(19) United States
(12) Patent Application Publication
(10) Pub. No.: US 2025/0085970 A1
(43) Pub. Date: Mar. 13, 2025

(54) SEMANTIC ORDERING FOR PARALLEL ARCHITECTURE WITH COMPUTE SLICES

(71) Applicant: Ascenium, Inc., Mountain View, CA (US)

(72) Inventor: Jacob John Vorland Taylor, 0558 Oslo (NO)

(73) Assignee: Ascenium, Inc., Mountain View, CA (US)

(21) Appl. No.: 18/826,260

(22) Filed: Sep. 6, 2024

Related U.S. Application Data
(60) Provisional application No. 63/659,401, filed on Jun. 13, 2024.
(60) Provisional application No. 63/642,391, filed on May 3, 2024.
(60) Provisional application No. 63/571,483, filed on Mar. 29, 2024.
(60) Provisional application No. 63/554,233, filed on Feb. 16, 2024.
(60) Provisional application No. 63/537,024, filed on Sep. 7, 2023.

(51) Int. Cl. G06F 9/30; G06F 9/38

(52) U.S. Cl. CPC G06F 9/30043; G06F 9/3836

(57) ABSTRACT

Techniques for managing compute slice tasks are disclosed. A processing unit comprising compute slices, load-store units (LSUs), a control unit, and a memory system is accessed. The compute slices are coupled. Each compute slice includes an LSU which is coupled to a predecessor LSU and a successor LSU. A compiled program is executed as the control unit distributes slice tasks to the compute slices for execution. A slice task, which includes a load instruction, is distributed to a current compute slice. The current compute slice can execute the slice task speculatively. A previously executed store instruction is committed to memory by a predecessor LSU. Address aliasing is checked between an address associated with the previously executed store instruction and the load address associated with the load instruction. The slice task running on the current compute slice can be cancelled when aliasing is detected.

### RELATED APPLICATIONS

This application claims the benefit of U.S. provisional patent applications “Semantic Ordering For Parallel Architecture With Compute Slices” Ser. No. 63/537,024, filed Sep. 7, 2023, “Compiler Generated Hyperblocks In A Parallel Architecture With Compute Slices” Ser. No. 63/554,233, filed Feb. 16, 2024, “Local Memory Disambiguation For A Parallel Architecture With Compute Slices” Ser. No. 63/571,483, filed Mar. 29, 2024, “Global Memory Disambiguation For a Parallel Architecture With Compute Slices” Ser. No. 63/642,391, filed May 3, 2024, and “Memory Dependence Prediction In A Parallel Architecture With Compute Slices” Ser. No. 63/659,401, filed Jun. 13, 2024.

Each of the foregoing applications is hereby incorporated by reference in its entirety.

### FIELD OF ART

This application relates generally to computer processing and more particularly to semantic ordering for parallel architecture with compute slices.

### BACKGROUND

Demand for compute power has been increasing since the computers were first devised. Conceptually, the idea of using vacuum tubes as logic gates was established prior to 1920. However, it wasn't until the late 1930s that the first vacuum tube computer was developed. The ENIAC computer soon followed with thousands of vacuum tubes, requiring an enormous amount of electricity while only providing roughly 450 floating point operations per second (FLOPS). Computers continued to slowly evolve with a steady increase in processing power. The invention of the transistor in 1947 enabled a new generation of computers and applications not previously achievable with vacuum-tube technology. As compute power increased, so did the ability to better harness their power through programming. Computer languages such as COBOL and FORTRAN were created to replace hard-to-use punch cards. These new computer programming languages significantly sped the process of making compute resources accessible to engineers to solve everyday problems. In the late 1950s, the first integrated circuit (IC) was created, marking another era in computer technology. From this point, the rate and pace of technological change intensified, including the development of the first general purpose microprocessor, the DRAM chip, and the floppy drive. Soon afterward, the first personal computers were created and brought to market.

Applications have evolved as computers have matured. Early computers were programmed though the use of patch cables and switches. As a result, they could realistically be used only for single-purpose tasks. Often, these tasks were related to the military such as breaking enemy cipher codes or directing artillery. The Turing machine, which included a stored program for the first time, opened new vistas of computer usage. Soon, general purpose computers were used for many non-military applications, culminating in the first personal computers. These machines, along with operating systems such as DOS and Windows, made word processing, spreadsheets, and even games popular for the masses.

Today, a smartphone has more than a million times the compute power of early computers described above. A standard personal computer today is roughly capable of tens of gigaFLOPs (1 billion floating point operations per second). Meanwhile, the world's fastest supercomputer is much more powerful, with more than eight million processor cores and a total compute power surpassing one exaFLOP (1 quintillion floating point operations per second). Predictably, this exponential increase in compute power has opened a world of new and powerful applications. Augmented reality, genomic sequencing, machine learning, artificial intelligence, cancer treatments, and autonomous vehicles are just a small sample of what has become possible with the power of today's high-performance processors and compute systems. In the future, human ingenuity will surely continue to push the technical boundaries of possibility as more processing power and new applications become available.

### SUMMARY

From the beginning, engineers have found ways to increase the performance of computer systems. Faster clock speeds have been applied with great success to increase the processing capability of modern compute systems. However, power dissipation has limited how far clock speeds can be pushed. As a result, the growth in processor clock rates has slowed as cooling technology has not been able to keep pace with improved frequencies. Parallelism has offered an additional method to increase performance. For example, a microprocessor chip can include any number of smaller cores, each able to perform operations in parallel. This approach, while common, has required engineers to devise methods of ensuring that each core has access to read and write to memory. The system must also be prevented from receiving stale data, and must deliver the most updated data to all processing elements when required. As more and more parallelism has been added to microprocessor chips, memory system design has become a significant challenge. To address the continued need for increased performance, a parallel architecture with compute slices and semantic ordering is disclosed.

Techniques for managing compute slice tasks are disclosed. A processing unit comprising compute slices, load-store units (LSUs), a control unit, and a memory system is accessed. The compute slices are coupled. Each compute slice includes an LSU which is coupled to a predecessor LSU and a successor LSU. A compiled program is executed as the control unit distributes slice tasks to the compute slices for execution. A slice task, which includes a load instruction, is distributed to a current compute slice. The current compute slice can execute the slice task speculatively. A previously executed store instruction is committed to memory by a predecessor LSU. Address aliasing is checked between an address associated with the previously executed store instruction and the load address associated with the load instruction. The slice task running on the current compute slice can be cancelled when aliasing is detected.

A processor-implemented method for memory operations is disclosed comprising: accessing a processing unit comprising a plurality of compute slices, a plurality of load-store units (LSUs), a control unit, and a memory system, wherein each compute slice within the plurality of compute slices includes at least one execution unit and is coupled to a successor compute slice and a predecessor compute slice, wherein each compute slice within the plurality of compute slices includes a unique LSU in the plurality of LSUs, and wherein each LSU in the plurality of LSUs is coupled to a successor LSU and a predecessor LSU; distributing a current slice task, by the control unit, to a current compute slice in the plurality of compute slices, wherein the current compute slice includes a current LSU, wherein the current slice task includes a load instruction, and wherein the current compute slice is not a head slice; saving, in an entry of a load address buffer (LAB) within the current LSU, a load address associated with the load instruction; checking for address aliasing between the entry of the LAB and a store address associated with a previously executed store instruction; and executing the load instruction. In embodiments, the checking did not detect address aliasing. In embodiments, the previously executed store instruction was executed by the current LSU. Some embodiments comprise collecting, in a store buffer within the current LSU, address data associated with the previously executed store instruction. In embodiments, the checking includes the address data that was collected in the store buffer within the current LSU. Some embodiments comprise returning data, for the load instruction, from the previously executed store instruction, wherein the checking detected address aliasing.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for semantic ordering for parallel architecture with compute slices.

FIG. 2 is a flow diagram for propagating a store address.

FIG. 3 is a block diagram for compute slice and load-store unit control.

FIG. 4 is a block diagram for a ring configuration of compute slices and load-store units.

FIG. 5 is a block diagram for slice control with local alias detection.

FIG. 6 is a block diagram for slice control with alias detection.

FIG. 7 is a block diagram for slice control with no alias detection.

FIG. 8 is a block diagram for slice control with alias detection and back-to-back commit.

FIG. 9 is a system diagram for semantic ordering for parallel architecture with compute slices.

### DETAILED DESCRIPTION

The need for compute power in organizations continues to rise. As new technologies such as artificial intelligence find application in common tasks, even low-tech organizations are faced with a need for upgrading their compute resources to remain competitive. Faster clock speeds have been applied with great success to increase the processing capability of modern compute systems. However, cooling technology has not been able to keep pace with improved lithography and increased frequencies, forcing other methods of performance improvements, such as parallelism, to be explored. Adding parallelism can be accomplished by increasing the number of execution units on a processor, enabling threading within the processor, and/or adding multiple processor cores to the same chip. These options increase overall performance by enabling the system to take advantage of more instruction level parallelism (ILP). However, these approaches also come with significant cost and complexity. For example, instructions and data must be able to move efficiently in and out of multiple processor cores on the same chip concurrently so that the processors do not stall, effectively reducing any performance that was gained. Further, memory semantics must be maintained across all cores in the system so that memory does not become corrupted, and each core operates on the most recent data, even if updated by another core in the system. Thus, highly efficient memory system designs have become a key piece to increase processor performance.

To address the continued need for increased performance, a parallel architecture with compute slices and semantic ordering is disclosed. A compiled program is divided into slice tasks. Slice tasks comprise code sequences of various sizes which include at least one branch instruction. The branch instruction, such as a conditional branch instruction, can include an expression and two or more paths or sides. A control unit can allocate any number of slice tasks to compute slices, one slice task per compute slice. The control unit can allocate an initial slice task, which can be a predecessor slice task, that can run non-speculatively while all other successive slice tasks run speculatively. The control unit can allocate a current slice task to a current compute slice, which can execute on the next immediate successor compute slice while the first slice block is executing. The allocation of the current slice task can be based on branch prediction logic within the control unit. The current slice task is the predicted next sequential slice task in the compiled program. Thus, the predicted outcome side of the branch operation can be executed in parallel while a branch decision is being made. The current slice task can be executed speculatively. Successor slice tasks can be allocated by the control unit at any time during execution of the compiled program. The branch decision determines which branch path or branch side to take based on evaluating an expression. The expression can include a logical expression, a mathematical expression, and so on. When the branch decision is determined, the control unit can check that the current slice task is a next sequential slice task in the compiled program. The checking is based on execution of the predecessor compute slice which is executing non-speculatively. If the current slice task is the next sequential slice task, then execution of the current slice task can proceed. If the current slice task is not the next sequential slice task, then results from the current slice task running on the second compute slice can be discarded.

Each compute slice is coupled to a successor compute slice and a predecessor compute slice by a barrier register set. The coupling can result in a ring configuration. The coupling of the compute slices enables data communication between compute slices. For example, a current compute slice can be coupled to an immediately succeeding compute slice by a current barrier register set. The current barrier register set provides unidirectional communication from the current compute slice to the successor compute slice. Thus, the current compute slice can write to the current barrier register set and the successor compute slice can read from the current barrier register set. Pointers are used to determine how slice tasks are assigned and controlled by the control unit. The pointers can be part of the internal control unit state. The pointers can include a head pointer and a tail pointer. In embodiments, the head pointer indicates which compute slice is executing non-speculatively and therefore is known to be part of the executed program. In embodiments, the tail pointer indicates which compute slice was the last to receive a slice task by the control unit. A head slice can be a compute slice which is pointed to by the head pointer. Likewise, a tail slice can be a compute slice pointed to by a tail pointer. In embodiments, a compute slice can execute speculatively if it is not the head slice. In other embodiments, the control unit distributes a slice task to a compute slice succeeding the tail slice. After distribution, the control unit can update the tail slice to point to the succeeding compute slice for further distribution of slice tasks to downstream compute slices. The head pointer and the tail pointer can be updated, by the control unit, based on slice task execution status, branch operation outcome determination, and so on. Executing multiple slice tasks on two or more compute slices enables parallelized operations, increasing performance.

Programs that are executed by the compute slices within the processing unit can be associated with a wide range of applications. The applications can be based on data manipulation, such as image, video, or audio processing applications; AI and machine learning applications; business applications; data processing and analysis; and so on. The slice tasks that are executed can perform a variety of operations including arithmetic operations, shift operations, logical operations including Boolean operations, vector or matrix operations, tensor operations, and the like. The slice tasks can be executed based on branch prediction, operation precedence, priority, coding order, amount of parallelization, data flow, data availability, compute slice availability, communication channel availability, and so on. Slice tasks that comprise a compiled program are generated by a compiler. The compiler can include a general-purpose compiler, a hardware description-based compiler, a compiler written or “tuned” for the specific number of compute slices in the processor unit, a constraint-based compiler, a satisfiability-based compiler (SAT solver), and so on. Control is provided to the hardware by the control unit which allocates slice tasks to compute slices. Once issued, the slice tasks can execute independently from the control unit and other compute slices until they are halted by the control unit, indicate an exception, finish executing, etc. In this way, a compiled task can be executed by the processing unit.

The compute slices within the processing unit can be implemented with central processing units (CPUs), graphics processing units (GPUs), application specific integrated circuits (ASICs), field programmable gate arrays (FPGAs), processing cores, or other processing components or combinations of processing components. The compute slices can include heterogeneous processors, homogeneous processors, processor cores within an integrated circuit or chip, etc. The compute slices can be coupled to local storage, which can include load-store units, local memory elements, register files, cache storage, etc. The cache, which can include a hierarchical cache such as an L1, L2, and L3 cache, can be used for storing data such as intermediate results, compute slice operations, and the like. Any level of cache (e.g., L1, L2, L3, etc.) can be shared by two or more compute slices. The local storage can be coherent.

Semantic ordering of memory operations can be maintained by a load-store unit (LSU) which can be included in each compute slice. Each LSU can include a load address buffer (LAB). The load address buffer can store load addresses that are processed by the compute slice. Each LSU can include a store buffer. The store buffer can save store addresses that are executed by the slice task running on the compute slice. Each LSU can include a skid buffer. The skid buffer can store addresses from a previously executed store instruction that was executed on a predecessor LSU and has been committed to an architectural state when a back-to-back store commit sequence occurs. Each LSU, such as a current LSU, can include alias detection logic. The alias detection logic can detect when a load address in the current LSU matches a committing store sent by a predecessor LSU, indicating that aliasing has occurred between the slice task running on the current compute slice and a slice task running on a predecessor compute slice. In embodiments, the aliasing occurs with the immediately preceding compute slice. In other embodiments the aliasing occurs in a previous LSU. When aliasing is detected, the slice task running in the current compute slice can be cancelled. Alias detection and cancel signals can be cascaded to one or more successor LSUs so that slice tasks running on those successor compute slices can also be cancelled when address aliasing is detected.

Computer execution is enabled by accessing a processing unit which contains a plurality of compute slices, a plurality of load-store units, a control unit, and a memory system. Each compute slice within the plurality of compute slices includes at least one execution unit. The execution unit can include multicycle elements for multiplication, division, and square root computations; arithmetic logic units (ALUs); storage elements; scratchpads; and other components. The components can communicate among themselves to exchange data, signals, and so on. Each compute slice can be coupled to a successor (next) compute slice and a predecessor (previous) compute slice. Further, each compute slice can include a unique LSU. Similarly, each LSU can be coupled to a successor (next) LSU and a predecessor (previous) LSU. The control unit can distribute a current slice task to a current compute slice. The current slice task can include a set of instructions that will be executed by a current compute slice. The current slice task can include at least one load instruction. The compute slice can include a current LSU. In embodiments, the current compute slice is not a head slice, indicating that the current slice task is speculative. A load address associated with the load instruction can be saved in an entry of a load address buffer (LAB) within the current LSU. Address aliasing can be checked between the entry of the LAB and a store address associated with a previously executed store instruction. In embodiments, the checking occurs between multiple loads and multiple stores. The load instruction can then be executed by the current LSU.

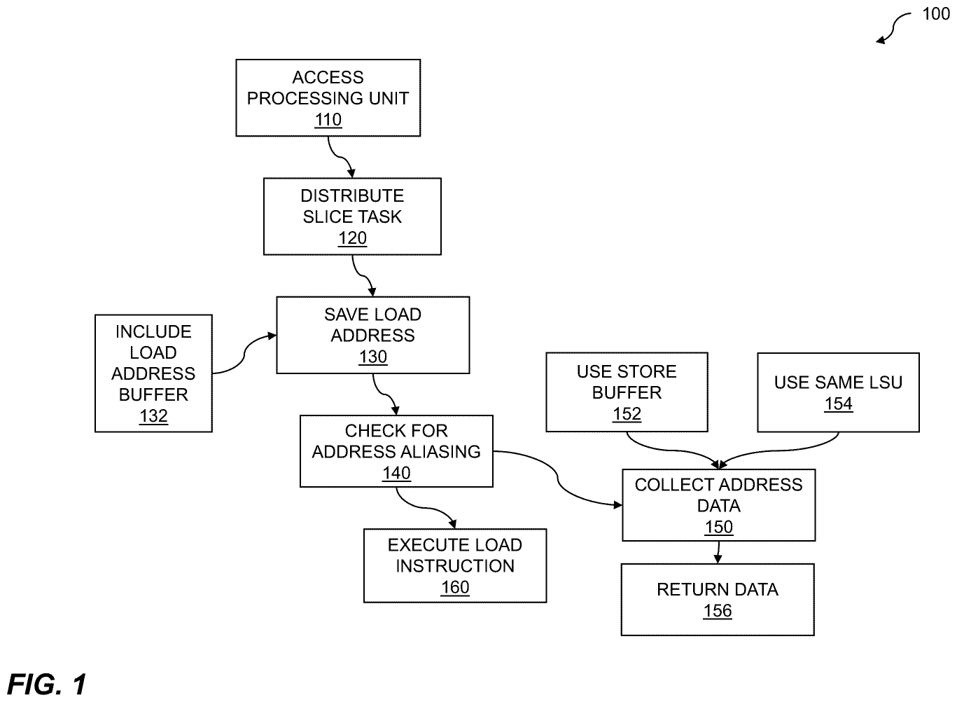

FIG. 1 is a flow diagram for semantic ordering for a parallel architecture with compute slices. Compute slices within a processing unit can be issued blocks of code, called slice tasks, for execution. The processing unit can include any number of compute slices. The slice tasks can be associated with a compiled program. The compiled program, when executed, can perform a variety of operations associated with data processing. The processing unit can include elements such as barrier register sets, a control unit, and a memory system. The processing unit can further interface with other elements such as ALUs, memory management units (MMUs), GPUs, multicycle elements (MEMs), and so on. The operations can accomplish a variety of processing objectives such as application processing, data manipulation, data analysis, modeling and simulation, and so on. The operations can accomplish artificial intelligence (AI) applications such as machine learning. The operations can manipulate a variety of data types including integer, real, and character data types; vectors, matrices, and arrays; tensors; etc. To maintain the integrity of the program, all memory operations are committed in program order. Load instructions associated with a slice task can be checked against previously executed store instructions. In embodiments, the checking can be performed against a previously executed store instruction that occurs in the same slice task as the load. In other embodiments, the checking can be performed against a previously executed store instruction that occurs in a predecessor slice task that was committed to an architectural state by a predecessor LSU that is in an active state. When an address alias is detected, results for successive slice tasks can be cancelled. Semantic ordering can be maintained across all compute slices by checking for address aliasing between compute slices before or during the committing process for store operations.

The flow 100 includes accessing 110 a processing unit comprising a plurality of compute slices, a plurality of load-store units (LSUs), a control unit, and a memory system, wherein each compute slice within the plurality of compute slices includes at least one execution unit and is coupled to a successor compute slice and a predecessor compute slice, wherein each compute slice includes a unique LSU in the plurality of LSUs, and wherein each LSU in the plurality of LSUs is coupled to a successor LSU and a predecessor LSU. The compute slices within the processing unit can be implemented with central processing units (CPUs), graphics processing units (GPUs), application specific integrated circuits (ASICs), field programmable gate arrays (FPGAs), processing cores, or other processing components or combinations of processing components. The compute slices can include heterogeneous processors, homogeneous processors, processor cores within an integrated circuit or chip, etc. In embodiments, compute slices within the processing unit have identical functionality. In other embodiments, the compute slices within the processing unit have different functionality. The compute slices can be coupled to a barrier register set which can enable data transfer between compute slices. The compute slices can share a variety of computational resources within the processing unit. In embodiments, the plurality of compute slices is coupled in a ring configuration. The ring configuration can include barrier registers which are coupled between compute slices. Each compute slice can include an LSU. In embodiments, the plurality of LSUs is coupled in a ring configuration. Other topologies are possible. The topology can be selected for a specific application such as machine learning. A topology for machine learning can include supervised learning, unsupervised learning, reinforcement learning, and other machine learning topologies. A topology for machine learning can include an artificial neural network topology. The compute slices can be coupled to other elements within the processing unit. In embodiments, the coupling of the compute slices enables one or more further topologies. The other elements to which the compute slices can be coupled can include storage elements such as a scratchpad memory, one or more levels of cache storage, multiplier units, buffers, register files, and so on.

The execution units within the compute slices can include multicycle elements for multiplication, division, and square root computations; arithmetic logic units (ALUs); storage elements; scratchpads; and other components. The components can communicate among themselves to exchange data, signals, and so on. In embodiments, more than one processing unit can be accessed. Two or more processing units can be colocated on an integrated circuit or chip, on multiple chips, and the like. In embodiments, two or more processing units can be stacked to form a three-dimensional (3D) configuration. The memory system can include local memory elements, register files, cache storage, etc. The cache, which can include a hierarchical cache, can be used for storing data such as intermediate results, compute slice operations, and the like. The cache can include an L1 cache, L2, cache, L3 cache, and so on. Any level of cache can be shared by two or more compute slices. In embodiments, the cache architecture is write-through. In other embodiments, the cache architecture is write-back. In some embodiments, the hierarchical cache is coherent. The control unit can be coupled to each of the compute slices within the processor unit. The control unit and the compute slices can communicate status information about the compute slice and execution status of a slice task. In embodiments, the status information can include bits which determine the state of the compute slice, such as idle, executing, holding, done, and so on.

A compiled program is divided into slice tasks. Slice tasks comprise code sequences of various sizes which include at least one branch instruction. The branch instruction, such as a conditional branch instruction, can include an expression and two or more paths or sides. A control unit can allocate any number of slice tasks to compute slices, one slice task per compute slice. The control unit can allocate an initial slice task, which can be a predecessor slice task that can run non-speculatively while all other successive slice tasks run speculatively. The control unit can allocate a current slice task to a current compute slice, which can execute on the next immediate successor compute slice while the first slice block is executing. The allocation of the current slice task can be based on branch prediction logic within the control unit. The current slice task is the predicted next sequential slice task in the compiled program. Thus, the predicted outcome side of the branch operation can be executed in parallel while a branch decision is being made. The current slice task can be executed speculatively. Successor slice tasks can be allocated by the control unit at any time during execution of the compiled program. The branch decision determines which branch path or branch side to take based on evaluating an expression. The expression can include a logical expression, a mathematical expression, and so on. When the branch decision is determined, the control unit can check that the current slice task is a next sequential slice task in the compiled program. The checking is based on execution of the predecessor compute slice which is executing non-speculatively. If the current slice task is the next sequential slice task, then execution of the current slice task can proceed. If the current slice task is not the next sequential slice task, then results from the current slice task running on the second compute slice can be discarded.

Each compute slice is coupled to a successor compute slice and a predecessor compute slice by a barrier register set. The coupling can result in a ring configuration. The coupling of the compute slices enables data communication between compute slices. For example, a current compute slice can be coupled to an immediately succeeding compute slice by a current barrier register set. The current barrier register set provides unidirectional communication from the current compute slice to the successor compute slice. Thus, the current compute slice can write to the current barrier register set and the successor compute slice can read from the current barrier register set. Pointers are used to determine how slice tasks are assigned and controlled by the control unit. The pointers can be part of the internal control unit state. The pointers can include a head pointer and a tail pointer. In embodiments, the head pointer indicates which compute slice is executing non-speculatively, and therefore is known to be part of the executed program. In embodiments, the tail pointer indicates which compute slice was the last to receive a slice task by the control unit. A head slice can be a compute slice which is pointed to by the head pointer. Likewise, a tail slice can be a compute slice pointed to by a tail pointer. In embodiments, a compute slice can execute speculatively if it is not the head slice. In other embodiments, the control unit distributes a slice task to a compute slice succeeding the tail slice. After distribution, the control unit can update the tail slice to point to the succeeding compute slice for further distribution of slice tasks to downstream compute slices. In embodiments, the head pointer and the tail pointer point to the same compute slice. The head pointer and the tail pointer can be updated, by the control unit, based on slice task execution status, branch operation outcome determination, and so on. Executing multiple slice tasks on two or more compute slices enables parallelized operations, increasing performance.

The flow 100 includes distributing 120 a current slice task, by the control unit, to a current compute slice in the plurality of compute slices, wherein the current compute slice includes a current LSU, wherein the current slice task includes a load instruction, and wherein the current compute slice is not a head slice. As previously described, a compiled program is divided into slice tasks, wherein each slice task contains at least one branch instruction. The dividing can be based on branch prediction logic. In embodiments, the control unit distributes a slice task to a compute slice, which can be a current compute slice. A current compute slice can be a reference to any compute slice in the plurality of compute slices. The current compute slice can execute a slice task which can be a current slice task. In embodiments, the current slice task includes a load instruction. The load instruction can be a direct load, indirect load, or any other type of load instruction. The load instruction can be executed by a current LSU, which can be included in the current compute slice. The current LSU can convert virtual addresses to physical addresses, load data from the memory system, store data to the memory system, and so on. In embodiments, the current LSU is coupled to a successor LSU and a predecessor LSU. In other embodiments the LSUs are coupled in a ring configuration, wherein each LSU can communicate with its succeeding LSU. The communications can include a store address if a store instruction is being committed, if aliasing was detected, and so on. In embodiments, a current LSU receiving a communication from its predecessor LSU triggers actions by the current LSU. For example, the communication can result in sending a communication to a successor LSU, holding or cancelling a pending load or store instruction in a buffer, and so on. In a usage example, a current LSU receiving a communication from its predecessor LSU triggers actions by the current compute slice, such as cancelling the entire first slice task. Many actions are possible.

As described earlier, pointers are used to determine how slice tasks are assigned and controlled by the control unit. The pointers can be part of the internal control unit state. The pointers can include a head pointer and a tail pointer. In embodiments, the head pointer indicates which compute slice is executing non-speculatively and therefore is known to be part of the compiled program. In embodiments, the tail pointer indicates which compute slice was the last to receive a slice task by the control unit. A head slice is a compute slice which is pointed to by the head pointer within the control unit. Likewise, a tail slice is a compute slice pointed to by a tail pointer within the control unit. In embodiments, a compute slice executes speculatively if it is not the head slice. Thus, the distributing 120 can result in a compute slice executing a slice task speculatively. In other embodiments, the control unit distributes a slice task to a compute slice which succeeds the tail slice. After distribution, the control unit can update the tail pointer to point to the next succeeding compute slice for further distribution of slice tasks to downstream compute slices.

The flow 100 includes saving 130, in an entry of a load address buffer (LAB) within the current LSU, a load address associated with the load instruction. Each LSU included in each compute slice can include a load address buffer (LAB). The LAB 132 can include any number of entries including 2, 4, 8, 16, or more. LABs within different LSUs can contain the same or a different number of entries. An LAB entry can contain a load address associated with the load instruction. The load instruction can be included in the current slice task executing on the current compute slice. The execution of the load instruction can return data in memory associated with the memory address. In embodiments, the load instruction, such as fetching operands, computing a memory address, accessing memory, writing the memory value to a destination register, and so on, is accomplished in pipeline stages within the current LSU. The load instruction can be direct, indirect, or any other type of load instruction. The data can be obtained from anywhere in the memory hierarchy, including caches such as the L1, L2, and L3 caches, etc. The data can be in main memory, on a storage disk, and so on. In embodiments, the load address is virtual. In other embodiments, the current LSU can communicate with a translation lookaside buffer (TLB) to translate the virtual address to a physical address to access the memory hierarchy. The load address can be saved in the LAB at the start of execution of the load instruction. In embodiments, the load address can be saved any time during the execution of the load instruction.

The flow 100 includes checking for address aliasing 140 between the entry of the LAB and a store address associated with a previously executed store instruction. As previously detailed, a current compute slice can include a load instruction to be executed by a current LSU within a compute slice. When the load instruction executes, the current LSU can save information pertaining to the load instruction in its LAB. In embodiments, the information includes the load address. An address associated with a previously executed store instruction can be received by the current LSU. In embodiments, the previously executed store address originates from a predecessor LSU that is included with the head slice (e.g., it is not executing speculatively). In other embodiments, the previously executed store address originates from the current LSU that also executed the load instruction. In further embodiments, the current LSU can check the store address that was received with the entries that are in the LAB. The checking can include a single LAB entry. In embodiments, the checking includes multiple LAB entries. In other embodiments, the checking can be based on a hash function of the store address. In further embodiments, the checking can be based on the entire store address. In embodiments, the checking for address aliasing occurs in a single cycle. In other embodiments, the checking for address aliasing occurs in two or more cycles. If the checking results in a match, then address aliasing has been detected between the previously executed store and the entry of an LAB.

The flow 100 includes collecting 150, in a store buffer 152 within the current LSU, address data associated with the previously executed store instruction. The collecting 150 can occur when the previously executed store instruction was executed by the current LSU. A current compute slice can execute a current slice task with an associated current LSU. The current LSU can be coupled to a predecessor LSU within a predecessor compute slice running a predecessor slice task. The current LSU can be coupled to a successor LSU within a successor compute slice running a successor slice task. A previously executed store address can originate from the current LSU 154 when running speculatively (e.g., it is not the head slice). The current LSU 154 can also execute a load instruction speculatively. If the load instruction occurs in a program order after the store instruction, the LSU may receive incorrect data because store instructions are not allowed to write to memory until the slice task is the head slice. Thus, if a load instruction aliases a previously executed store instruction from the same LSU, the load instruction will load incorrect data from memory. To address this issue, data associated with the previously executed store instruction can be collected in a store buffer 152 within the current LSU 154. The store buffer 152 can have any number of entries including 2, 4, 8, 16, or more. Thus, the store buffer can contain entries for more than one previously executed store instruction. Each entry within the store buffer 152 can include the store address, data to be written to memory, and so on. When the load instruction is executed by the current LSU, it can check for address aliasing between the load address and any previously executed store addresses that were saved in the store buffer. Thus, in embodiments, the checking includes the address data that was collected in the store buffer within the current LSU 154. In other embodiments, the checking for address aliasing can occur in a single cycle. In other embodiments, the checking for address aliasing can occur in two or more cycles. If the checking detects an alias between the load address and the previously executed store address from the current LSU, the data associated with the store instruction can be returned 156 to the load instruction and speculative program execution can continue within the current slice task. Thus, further embodiments include returning data, for the load instruction, from the previously executed store instruction, wherein the checking detected address aliasing.

In embodiments, the checking includes a second previously executed store instruction. The second previously executed store instruction can be executed by the current LSU prior to execution of the load instruction. The second previously executed store instruction can be stored in the store buffer and alias checking can proceed as above between the load instruction and all store data in the store buffer. In other embodiments, the current slice task includes a second load instruction. The address associated with the second load instruction can be checked against one or more entries within the store buffer. If an alias occurs, the second load instruction can be satisfied by the previously executed store instruction saved in the store buffer which aliased the load. In embodiments, a load instruction that has been saved in the LAB can be used for the alias checking. When the control unit makes the current compute slice the head slice, the stores within the store buffer can be safely flushed to memory, committing the data associated with the store instruction to an architectural state. The committing can include saving the data to a data cache.

The flow 100 includes executing the load instruction 160. As previously described, alias checking by the current LSU can include addresses from one or more previously executed store instructions from the current LSU or a predecessor LSU. If the checking did not detect address aliasing with a previously executed store instruction, then memory can be safely accessed by the load instruction in the current LSU. Thus, it is safe for the compute slice to execute the load instruction. The execution can include returning, from memory, data associated with the load address. The data can be located anywhere in the memory hierarchy, including L1, L2, L3 caches, or in main memory. In embodiments, the load address is virtual. In other embodiments, the LSU can communicate with a translation lookaside buffer (TLB) to translate the virtual address to a physical address to access the memory hierarchy. The load data that is returned from the memory hierarchy can be stored in registers or in other storage elements within the compute slice. The load data can then be used in the execution of subsequent instructions in the slice task.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

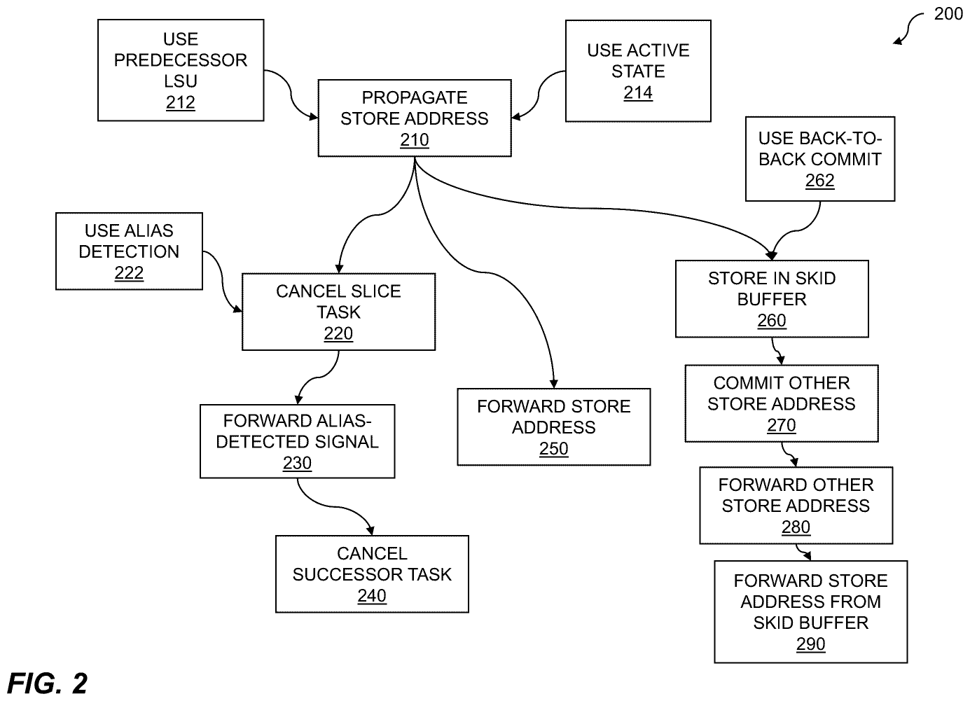

FIG. 2 is a flow diagram for propagating a store address. As described above and throughout, the control unit can distribute a current slice task to a current compute slice which includes a current LSU. The current compute slice can be executing the current slice task speculatively. Meanwhile, a store instruction can be executed by a predecessor LSU within a predecessor compute slice that is not running speculatively (e.g., the predecessor compute slice is the head slice). Because it was not executed speculatively, the store instruction can safely be committed to an architectural state by the predecessor LSU. However, since successor LSUs may be executing load instructions speculatively, checking must be performed to ensure that no address aliasing has taken place between the previously executed store and any speculative load instructions executing on any successor LSUs. A store address associated with a previously executed store that has been committed to an architectural state can be propagated by a predecessor LSU to one or more successor LSUs. If an alias is detected at the one or more successor LSUs, the slice task running in that compute slice can be discarded, as well as all successor slice tasks to that slice task which are running speculatively.

The flow 200 includes propagating, by a predecessor LSU 212, to the current LSU, the store address associated with the previously executed store instruction. The propagating can occur when the previously executed store instruction was executed by the predecessor LSU 212, wherein the previously executed store instruction was committed to an architectural state, and wherein the predecessor LSU is in an active state 214. A current compute slice can execute a current slice task with an associated current LSU. The current LSU can be coupled to a predecessor LSU within a predecessor compute slice running a predecessor slice task. The current LSU can be coupled to a successor LSU within a successor compute slice running a successor slice task. In embodiments, each of the LSUs in the processor unit includes an active state 214 or an inactive state (not shown in flow 200). The active state 214 can indicate that the LSU is busy. Examples of an active state can include: the LSU has buffered stores in the store buffer; the LSU is executing a load or store instruction; the LSU is in the process of committing a store; and so on. In embodiments, an LSU in the active state transitions to the inactive state after receiving a commit signal from the control unit once it has completed committing any buffered stores, when it is idle, and so on. Recall that a current slice task can include a load instruction which will be executed by the current LSU within the current compute slice. At the same time, its predecessor compute slice can be the head slice. In embodiments, the predecessor slice task includes a store instruction that was previously executed by the predecessor LSU 212. Since the store instruction was executed non-speculatively, it can safely commit and update an architectural state such as saving data in a data cache. In embodiments, the predecessor LSU is in the active state 214 since it is busy handling the store instruction. Under these conditions, the predecessor LSU can propagate 210 the previously executed store address that was committed to the current LSU.

The flow 200 includes cancelling the current slice task 220. Consider the above example wherein a predecessor LSU can propagate, to a current LSU, a store address of a previously executed store instruction which has been committed to an architectural state. In embodiments, the previously executed store instruction was executed by the immediately preceding LSU. In other embodiments, the store instruction was executed by an earlier LSU and the store address was forwarded through more than one predecessor LSU to the current LSU. In embodiments, upon receiving the previously executed store address, checking for address aliasing is performed against a load address that has been saved in the LAB of the current LSU. The LAB can save more than one load address. In embodiments, the checking detects address aliasing 222. When aliasing is detected, the current LSU can cancel the current slice task 220. Cancelling the slice task is necessary since the load that was executed by the LSU received data from the memory system before it was updated by the previously executed store instruction to the same address. That is, the load instruction received incorrect data and the execution of that slice task was corrupted. In embodiments, the current LSU transitions to an inactive state after the current slice task is cancelled. In other embodiments, the control unit updates the tail slice to be the compute slice preceding the current compute slice that was cancelled. In other embodiments, the control unit allocates a new slice task to the compute slice.

Downstream compute slices can depend on data from the current compute slice. However, because an alias was detected, results of the current compute slice are no longer reliable. In embodiments, all active downstream compute slices are cancelled. Once the current LSU detects aliasing, it can assert an alias detected signal. The alias detected signal can be sent to the successor LSU. Thus, the flow 200 includes forwarding, by the current LSU to the successor LSU, an alias detected signal 230. In embodiments, the current LSU must be in the active state before sending the alias detected signal. When the successor LSU receives the alias detected signal, it knows that a predecessor LSU detected an alias. In embodiments, the predecessor LSU can be the immediately preceding LSU. In other embodiments, an earlier LSU in the ring before the immediately preceding LSU sends the alias detected signal which is propagated to succeeding LSUs until it reaches the successor LSU. The propagating can include one processor unit clock cycle per propagation from one LSU to the next LSU.

The flow 200 includes cancelling execution of a successor slice task 240 associated with the successor LSU. Once the alias detected signal is received by the successor LSU, the successor LSU can signal to the successor compute slice to cancel execution of the successor slice task and transition to an inactive state. The control unit can be notified of the cancellation and can take actions. The actions can include moving the head pointer, moving the tail pointer, allocating another code slice on a compute slice that had execution cancelled, and so on. In embodiments, the LSUs are coupled in a ring configuration. The successor LSU can send the alias detected signal to the next LSU in the ring if the successor LSU is in the active state. In further embodiments, the sending of the alias detected signal continues until an LSU is reached that is in the inactive state.

The flow 200 includes forwarding 250, by the current LSU to the successor LSU, the store address associated with the previously executed store instruction. Consider again a current compute slice running a current slice task with an associated current LSU. The current LSU can be coupled to a predecessor LSU within a predecessor compute slice running a predecessor slice task. The current LSU can be coupled to a successor LSU within a successor compute slice running a successor slice task. In the above example a predecessor LSU can propagate, to the current LSU, a store address of a previously executed store instruction which has been committed to an architectural state. In embodiments, the previously executed store instruction was executed by the immediately preceding LSU. In other embodiments, the store instruction was executed by an earlier LSU in the ring and the store address was forwarded through more than one predecessor LSU to the current LSU. In embodiments, upon receiving the previously executed store address, checking for address aliasing is performed against a load address that has been saved in the LAB of the current LSU. In embodiments, the checking does not detect address aliasing. No alias detected signal is sent when aliasing is not detected. Thus, the current compute slice can continue to execute its slice task speculatively. However, downstream LSUs must check any loads within their LAB with the previously executed store address that was committed to an architectural state. To accomplish this, the current LSU can forward the previously executed store address to the successor LSU, if the current LSU is in an active state. In embodiments, the current LSU must be in the active state to forward the previously active store instruction. The forwarding can occur on the cycle following the alias detection by the current LSU. When the successor LSU receives the previously executed store address, it can also check for aliasing between the previously executed store address and any load address in its LAB. Thus, in embodiments, the checking includes the successor LSU. If an alias is detected, an alias detected signal can be sent from the successor LSU to the next LSU in the ring, assuming the successor LSU is in the active state. The alias detected signal can be used to cancel execution of the next LSU using disclosed mechanisms. If no alias is detected, the store address can again be forwarded to the next LSU using disclosed mechanisms. In embodiments, the forwarding continues until an LSU that is in the inactive state is found.

The flow 200 includes storing, in a skid buffer 260 within the current LSU, the store address that was propagated, wherein a back-to-back store commit 262 sequence occurs. To avoid stall cycles in the execution of the compiled program, the processor unit can support a back-to-back commit sequence. A back-to-back commit sequence can occur when two successive LSUs commit one or more store instructions in back-to-back cycles. Recall that a current compute slice can execute a current slice task with an associated current LSU. The current LSU can be coupled to a predecessor LSU within a predecessor compute slice running a predecessor slice task. The current LSU can be coupled to a successor LSU within a successor compute slice running a successor slice task. A back-to-back commit sequence can include four processor cycles: N, N+1, N+2, and N+3. In cycle N, a predecessor LSU, which is the head slice, has completed a predecessor slice task, and can indicate to the control unit that it is ready to commit one or more store instructions. In addition, the current LSU has completed speculative execution of the current slice task and is also ready to commit one or more other store instructions. In embodiments, the current LSU waits to be the head slice before it commits the one or more store instructions. In the next cycle, N+1, the predecessor LSU can commit the previously executed store to memory and propagate, to the current LSU, a store address of a previously executed store instruction which has now been committed to an architectural state. The store address of the previously executed store instruction can be saved in a skid buffer 260 within the current LSU. The skid buffer can include any number of entries including 1, 2, 4, and so on. The skid buffer 260 can save information from the previously executed store instruction including the store address, the data to be stored, and so on. In embodiments, the address is physical. In other embodiments, the address is virtual. The skid buffer 260 can vary in size between LSU units in the processor core. The skid buffer 260 can save addresses for multiple previously executed store instructions that updated an architectural state.

In the next cycle, N+2, the predecessor LSU can indicate to the control unit that all commits have been successful, the control unit can set the predecessor slice to the inactive state, the control unit can make the current compute slice the head slice, and the current LSU can check for aliasing between the previously executed store and any load addresses in its LAB. In embodiments, aliasing is detected, the current slice task can be discarded, and the back-to-back commit sequence can be halted. In other embodiments, the checking does not detect address aliasing. In this case, the back-to-back sequence can continue with the current compute slice committing the one or more other store instructions 270 to memory. Thus, in embodiments, the back-to-back commit sequence includes committing, by the current LSU, one or more other store instructions, one cycle after the predecessor LSU commits the previously executed store instruction. The current LSU can then commit the one or more other store instructions it executed and forward those other store addresses 280 to its successor LSU for alias detection. Thus, embodiments include forwarding 280, by the current LSU to the successor LSU, one or more other store addresses associated with the one or more other store instructions.

On the next cycle, N+3, the current LSU can send the address of the previously executed store instruction to the successor LSU from the skid buffer 260 for alias detection. The successor LSU can then perform alias detection in a future processor cycle. Thus, embodiments include forwarding, by the current LSU to the successor LSU, the store address 290 associated with the previously executed store instruction from the skid buffer. The current LSU can then enter the idle state. In this way, all previously executed store addresses can be checked for aliasing with load instructions in downstream LSUs, even if a back-to-back commit situation exists.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

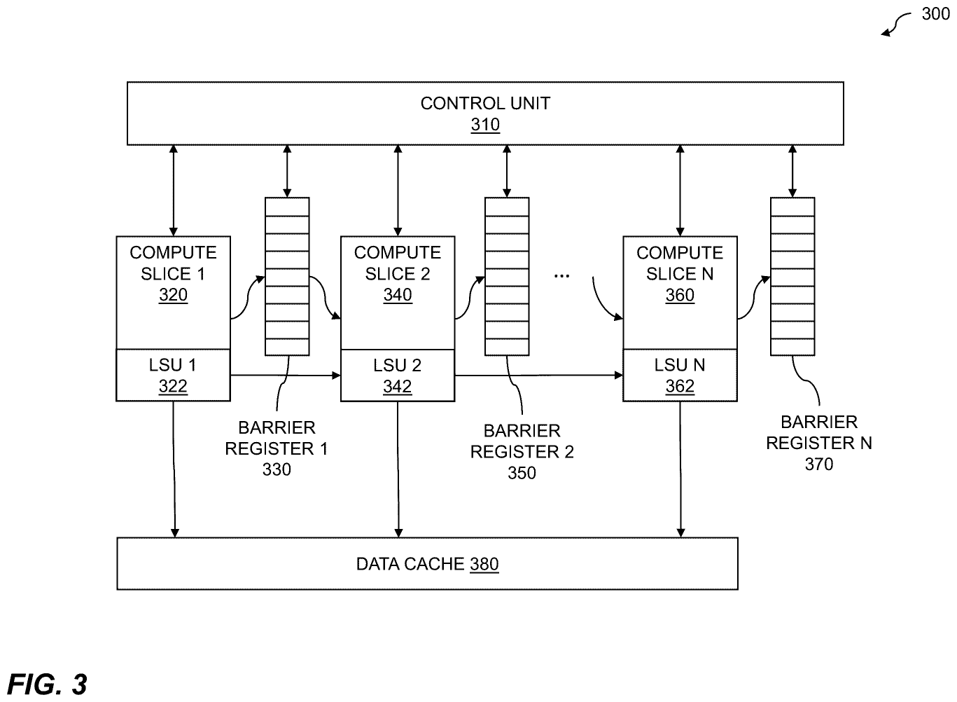

FIG. 3 is a block diagram for compute slice and load-store unit control. A processor unit can be used to process data for applications such as image processing, audio and speech processing, artificial intelligence and machine learning, and so on. The processor unit includes a variety of elements, where the elements include compute slices, a control unit, a memory system, busing and networking, and so on. In embodiments, each compute slice contains a load-store unit (LSU). The compute slices can obtain data for processing. The data can be obtained from the memory system, cache memory, a scratchpad memory, and the like. Compute slices can be coupled together using a barrier register, where a current compute slice can only write to the barrier register and a successor compute slice can only read from the barrier register. Each LSU can be coupled together, where a current LSU can only communicate with a successor LSU. The control unit can control data access, data processing, etc. by the compute slices. Compute slice control enables a parallel architecture with compiler-scheduled compute slices.

Compiled programs can be executed on a parallel processing architecture. Some slice tasks associated with the program, for example, can be executed in parallel, while others must be properly sequenced. The sequential execution and the parallel execution of the slice tasks are dictated in part by the existence of or absence of data dependencies between slice tasks. In a usage example, compute slice A, running slice task A, processes input data and produces output data that is required by compute slice B, running slice task B. Thus, for correct results, slice task A must first generate the input required by slice task B before slice task B can fully execute on compute slice B. In embodiments, slice task B can execute speculatively, wherein the speculative execution does not depend on inputs from slice task A. When slice B execution gets to the point where it depends on input from slice A, compute slice B can stall while waiting for results from the predecessor slice. Once the results are obtained, compute slice B can continue to execute slice task B speculatively while slice task A proceeds. Compute slice C, however, holds slice task C which executes instructions that process the same input data as slice task A and also produces its own output data. Thus, slice task C can be speculatively executed in parallel with slice tasks A and B.

The execution of tasks can be based on memory access operations, where the memory access operations include data loads from memory, data stores to memory, and so on. To continue the usage example above, slice task A running on compute slice A can include a store instruction executed by LSU A. In parallel, slice task B running speculative slice task B can include a load instruction executed by LSU B. LSU B can execute the load; however, it must later check for aliasing with the previously executed store from LSU A to ensure that it received the correct data. This can be accomplished by storing the load in a load address buffer (LAB) in LSU B. Later, LSU A can forward the store address of the previously executed store instruction to LSU B. Alias checking can include comparing the previously executed store instruction and the load address in the LAB. If the addresses match (alias), then slice task B can be discarded by the control unit. Data can be moved between a memory, such as a memory data cache 380, and storage elements associated with the processing unit. The storage elements associated with the processing unit can include scratchpad memory, register files, and so on. The storage elements associated with the processing unit can include barrier register sets. Memory access operations can include loads from memory, stores to memory, memory-to-memory transfers, etc. The storage elements can include a local storage coupled to one or more compute slices, storage associated with the array, cache storage, a memory system, and so on.

Block diagram 300 can include a control unit 310 within the processor unit. The control unit can be used to control one or more compute slices, barrier registers, LSUs, and so on associated with the processing unit. The control unit can operate based on receiving a set of slice tasks from a compiler. The compiler can include a high-level computer, a hardware language compiler, a compiler developed for use with the processing unit, and so on. The control unit can distribute and allocate slice tasks to compute slices associated with the processing unit. The control unit can be used to commit a result of a slice task to a barrier register when execution of the slice task has been completed. The control unit can perform checking and control operations. The checking and control operations can include checking that a slice task is a next sequential slice task in a compiled program; distributing slice tasks; cancelling slice tasks; moving the head pointer and tail pointer; allowing a compute slice to commit results to memory; and so on. The control unit can perform state assignment operations. Embodiments include assigning, by the control unit, a state to each compute slice in the plurality of compute slices, wherein the state is one of idle, executing, holding, or done. The assigned states can be used to determine whether a compute slice is ready to receive a slice task, data is ready to be committed, etc. The state of a compute slice can be used for exception handling techniques. The exception handling techniques can be associated with nonrecoverable exceptions and recoverable exceptions.

The processing unit can include a plurality of compute slices. The compute slices can be issued, by the control unit, slice tasks for execution. The slice tasks can include blocks of code associated with a compiled program generated by the compiler. In the block diagram 300, the compute slices include compute slice 1 320, compute slice 2 340, and compute slice N 360. The number of compute slices that can be included in the processing unit can be based on a processing architecture, a number of processor cores on an integrated circuit or chip, and the like. A load-store unit (LSU) can be included in each compute slice. The LSU can be used to provide load data obtained from a memory system for processing on the associated code slice. The LSU can be used to hold store data generated by the compute slice and can be designated for storing in the memory system. The LSU can include LSU 1 322 included in compute slice 1 320, LSU 2 342 included in compute slice 2 340, and LSU N 362 included in compute slice N 360. As the number of compute slices changes for a particular processing unit architecture, the number of LSUs can change correspondingly. The LSUs can be coupled, enabling direct communication of data and control signals from one LSU to a successor LSU. In the block diagram 300, LSU 1 322 can communicate with LSU 2 342. LSU 2 342 can communicate with LSU 3 (not shown). LSU N 362 can communicate with LSU N+1 (not shown). The communication can include sending alias detected signals, store addresses, and so on. The communication can include signals that control execution of the compute slice associated with the LSU. In a usage example, an alias detected signal can be sent from LSU 1 322 to LSU 2 342. In response, LSU 2 342 can signal to compute slice 340 to cancel execution of its slice task. Slice tasks can be issued to compute slices in an order. In 300, this order can be visualized as from left to right. That is, a left-hand LSU or predecessor LSU only has to communicate to an LSU associated with a right-hand LSU or successor. That is, a successor LSU does not have to send data or control signals to a predecessor LSU, nor does a predecessor compute slice have to read from a successor compute slice. In an implementation example, a successor LSU can be to the left or the right of its predecessor. In further embodiments, the plurality of LSUs can be coupled in a ring configuration.

The processing unit can include a plurality of sets of barrier registers. The barrier registers can be used to hold load data to be processed by a compute slice, to receive store data generated by a compute slice, and so on. In embodiments, a second compute slice can be coupled to a first compute slice by a first barrier register set in the plurality of barrier register sets. In the block diagram, barrier register 1 330 can couple compute slice 2 340 to compute slice 1 320, barrier register 2 350 can couple compute slice 3 (not shown) to compute slice 2 340, barrier register N 370 can couple compute slice N+1 (not shown) to compute slice N 360, etc. Slice tasks can be issued to compute slices in an order. In the block diagram 300, this order can be visualized as from left to right. That is, a left-hand compute slice or predecessor compute slice only has to write to a barrier register coupled to a right-hand compute slice or successor. A successor compute slice does not have to write to a processor compute slice, nor does a predecessor compute slice have to read from a successor compute slice. In an implementation example, a successor compute slice can be to the left or the right of its predecessor. In further embodiments, the plurality of compute slices and the plurality of barrier register sets can be coupled in a ring configuration. Thus, barrier register N 370 can be coupled between compute slice N 360 and compute slice 1 320.

Data movement, whether loading, storing, transferring, etc., can be accomplished using a variety of techniques. In embodiments, memory system access operations can be performed outside of processing unit, thereby freeing the compute slices with the processing unit to execute slice tasks. Memory access operations, such as autonomous memory operations, can preload data needed by one or more compute slices. The preloaded data can be placed in buffers associated with compute slices that require the data. In additional embodiments, a semi-autonomous memory copy technique can be used for transferring data. The semi-autonomous memory copy technique can be accomplished by the processing unit which generates source and target addresses required for the one or more data moves. The processing unit can further generate a data size such as 8, 16, 32, or 64-bit data sizes, and a striding value. The striding value can be used to avoid overloading a column of storage components such as a cache memory.

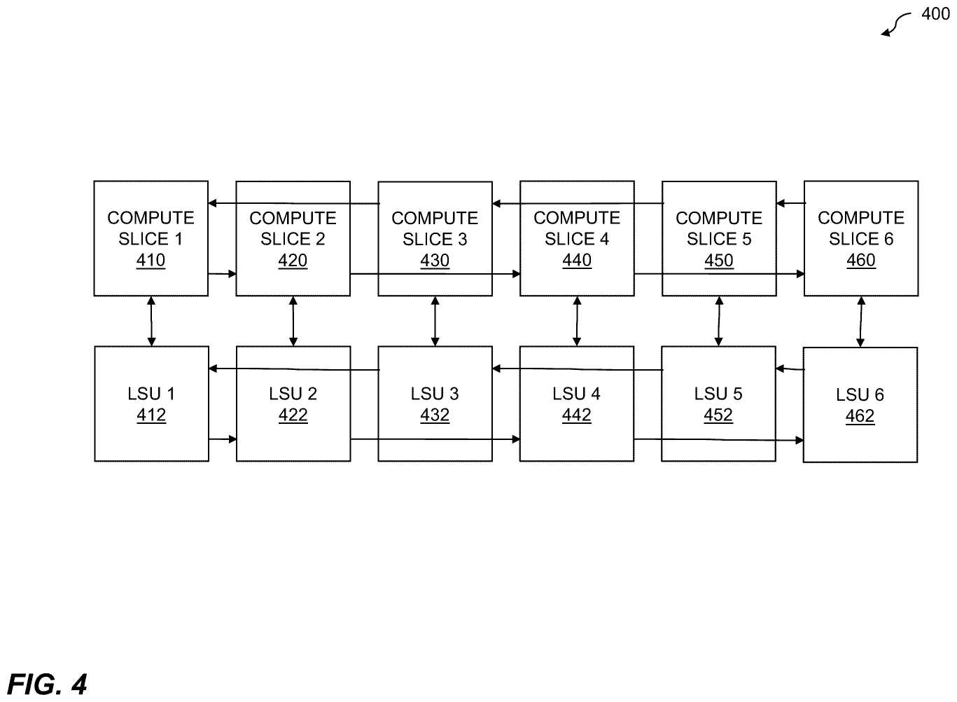

FIG. 4 is a block diagram for a ring configuration of compute slices and load-store units. Described previously and throughout, a processing unit can be used to execute a compiled program. The program can be associated with processing applications such as image processing, audio processing, and natural language processing applications. The processing can be associated with artificial intelligence applications such as machine learning. The processing unit can include various elements such as compute slices and load-store units (LSUs). Each compute slice can independently execute a block of code called a slice task. The slice tasks that can be associated with the compute slices can also be associated with a compiled program. The execution of the slice tasks can be controlled by a local program counter associated with each compute slice. Communication between a compute slice and its immediate neighbors, such as a predecessor compute slice and a successor compute slice, is accomplished using a barrier register set. A current compute slice is not required to write to a predecessor compute slice, nor to read from a successor compute slice. A ring configuration of compute slices is shown 400. The compute slices within the ring configuration can include compute slice 1 410, compute slice 2 420, compute slice 3 430, compute slice 4 440, compute slice 5 450, compute slice 6 460, and so on. While six compute slices are shown, the ring of compute slices can also comprise more or fewer compute slices. The compute slice ring configuration can be accomplished using an integrated circuit or chip, a plurality of compute slice cores, a configurable chip, and the like. The ring configuration can be based on a regularized circuit layout, equalized interconnect lengths, and so on. Each compute slice, such as compute slice 3 430, can be coupled to a successor compute, such as compute slice 1 410, and a predecessor compute slice, such as compute slice 5 450. The coupling can include a barrier register set. In a usage example, the compute slice 3 430 can only write to the barrier register and compute slice 1 410 can only read from the barrier register. This architectural technique can ensure that a compute slice that requires input data from a predecessor compute slice can read valid data. That is, the current compute slice generates data, branch decisions, etc., and writes this information to the input of the barrier register while the output of the register remains unchanged. The data being read at the output of the barrier register will remain valid while the successor compute slice is processing data. The results from the first compute slice are not committed until after the current compute slice has completed execution and the successor compute slice has obtained its data. The committing is performed by the control unit. This technique eliminates a race condition such as a write-before-read race condition.

Each of the compute slices can include a unique LSU from a plurality of LSUs. An LSU can be coupled between a predecessor and a successor LSU and can be used to execute memory instructions, convert virtual addresses to physical addresses, and so on. Pointers such as a head pointer and a tail pointer can be used to direct blocks of code issued by a control unit to the compute slices for execution. A plurality of LSUs can be coupled in a ring configuration. The LSU ring configuration enables semantic ordering for a parallel architecture with compute slices. In the block diagram 400, compute slice 1 410 includes LSU 1 412, compute slice 2 420 includes LSU 2 422, compute slice 3 430 includes LSU 3 432, computes slice 4 440 includes LSU 4 442, compute slice 5 450 includes LSU 5 452, and compute slice 6 460 includes LSU 6 462. While six LSUs are shown, the ring of LSUs can also comprise more or fewer LSUs, according to the number of compute slices in the processor unit. The LSU ring configuration can be accomplished using an integrated circuit or chip, a plurality of compute slice cores, a configurable chip, and the like. The ring configuration can be based on a regularized circuit layout, equalized interconnect lengths, and so on. Each LSU, such as LSU 3 432, can be coupled to a successor LSU, such as LSU 1 412, and a predecessor LSU, such as LSU 5 452. Each LSU can handle data and instruction transfers between the compute slices and a memory system. Further, each compute slice and LSU can be coupled to a control unit (not shown). The control unit can enable loading and execution of slice tasks, loading and storing data in barrier registers, etc. The coupling of the LSUs enables direct communication of data and control signals from one LSU to a successor LSU. The communication can include sending alias detected signals, store addresses, and so on. The communication can include signals that control execution of the compute slice associated with the LSU.

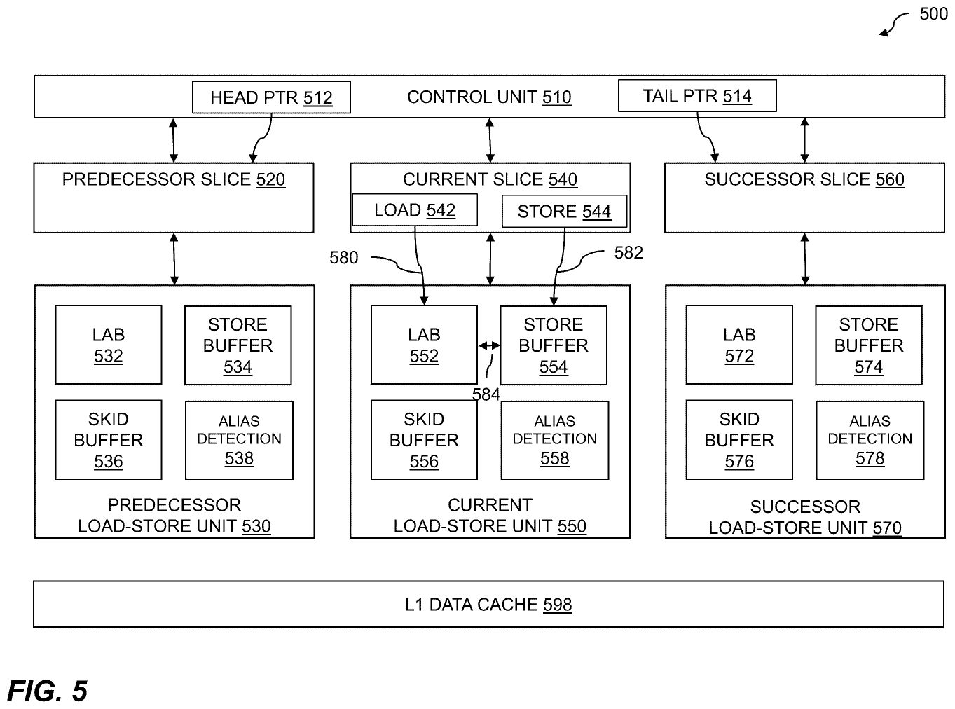

FIG. 5 is a block diagram for slice control with local alias detection. As described above and throughout, a compiled program is divided into slice tasks, wherein each slice task contains at least one branch instruction. The dividing can be based on branch prediction logic within the control unit. The control unit can distribute the slice tasks to one or more compute slices. Each compute slice can include its own load-store unit (LSU). In the block diagram 500, three compute slices are shown: a predecessor compute slice 520 (also called a predecessor slice), a current compute slice 540 (also called a current slice), and a successor compute slice 560 (also called a successor slice). A plurality of compute slices can be coupled together in a ring configuration. Additional compute slices can be included in the processor unit. The control unit 510 can distribute a slice task to one or more of the compute slices shown. In the example of block diagram 500, predecessor slice 520 is executing a predecessor slice task that was distributed by the control unit 510. In this example, predecessor slice 520 is the head slice. A head slice is a compute slice which is pointed to by a head pointer 512 within the control unit. In embodiments, when a compute slice is the head slice, it executes its slice task non-speculatively. Current slice 540 is executing a current slice task that was distributed by the control unit 510 speculatively since it is not the head slice. Likewise, successor slice 560 is also running a successor slice task, distributed by the control unit 510, speculatively. Successor slice 560 is the tail slice. A tail slice is a compute slice which is pointed to by a tail pointer 514 within the control unit. In embodiments, the tail pointer indicates the last compute slice in the ring that is executing a slice task.

In the block diagram 500, each compute slice includes its own LSU. Thus, the predecessor slice 520 includes predecessor LSU 530; current slice 540 includes current LSU 550; and successor slice 560 includes successor LSU 570. A plurality of LSUs can be coupled together in a ring configuration. Each LSU can include multiple elements. Predecessor LSU 530 includes a load address buffer (LAB) 532, a store buffer 534, a skid buffer 536, and alias detection logic 538. Additional logic blocks can be included in 530 for additional functions such as address translation, etc. Likewise, current LSU 550 can include an LAB 552, a store buffer 554, a skid buffer 556, and alias detection logic 558. Additional logic blocks can be included in 550 for additional functions such as address translation, etc. Continuing in block diagram 500, successor LSU 570 can include an LAB 572, a store buffer 574, a skid buffer 576, and alias detection logic 578. Additional logic blocks can be included in 570 for additional functions such as address translation, etc. Each compute slice can access an L1 data cache 598. In embodiments, the L1 data cache is shared among two or more compute slices. In other embodiments, each LSU is coupled to its own L1 data cache. The L1 data cache can be coupled to a memory hierarchy which can include an L2 cache, an L3 cache, and so on. Any of the caches can be shared by two or more compute slices. The memory hierarchy can be coherent. Each LSU in the processor unit can be in an active or inactive state. Examples of an active state can include: the LSU has buffered stores in the store buffer; the LSU is executing a load or store instruction; the LSU is in the process of committing a store; and so on. In embodiments, an LSU in the active state transitions to the inactive state after receiving a commit signal from the control unit, once it has completed committing any buffered stores, when it is idle, and so on. In embodiments, an LSU that is in an inactive state is prohibited from forwarding addresses for alias checking to a next LSU in the ring. In the block diagram 500, the predecessor LSU 530, current LSU 550, and successor LSU 570 are all in the active state.

In embodiments, a previously executed store instruction was executed by the current LSU 550 running a current code slice. This is referred to as local address aliasing. That is, the current code slice can contain a load instruction 542 and a store instruction 544. If the load instruction 542 occurs in program order after the store instruction 544, and there is local aliasing, the LSU can receive incorrect data from memory. This is because store instructions are not allowed to write to memory until the current slice is the head slice. To address this local aliasing issue, embodiments include collecting 582, in a store buffer 554 within the current LSU, address data associated with the previously executed store instruction 544. The store buffer 554 can have any number of entries including 2, 4, 8, 16, or more. Thus, the store buffer can contain entries for more than one previously executed store instruction. Store buffers within different LSUs can contain the same or a different number of entries. Each entry within the store buffer 554 can include the store address, data to be written to memory, and so on. When the load instruction executes, the LSU 550 can save information 580 pertaining to the load instruction 542 in the LAB 552. In embodiments, the information includes the load address. The LAB 552 can include any number of entries including 2, 4, 8, 16, or more. LABs within different LSUs can contain the same or a different number of entries. Each LAB entry can contain a load address from a load instruction.

When the load instruction 542 is executed by the current LSU 550, it can check for local address aliasing between the load address saved in the LAB 552 and any previously executed store addresses from the current LSU 550 that were saved in the store buffer 554. Thus, in embodiments, the checking can include the address data that was collected in the store buffer within the LSU 550. In other embodiments, the checking for local address aliasing can occur in a single cycle. In further embodiments, the checking for local address aliasing can occur in two or more cycles. If the checking detects a local alias between the load address and the previously executed store address from the current LSU 550, the data associated with the store instruction 544 can be returned 584 to the load instruction 542 and speculative program execution can continue within the current slice task. Thus, further embodiments include returning data, for the load instruction, from the previously executed store instruction, wherein the checking detected address aliasing.

In embodiments, the checking includes a second previously executed store instruction. The second previously executed store instruction can be executed by the current LSU 550 prior to execution of the load instruction. The second previously executed store instruction can be stored in the store buffer 554 and alias checking can proceed as above between the load address in the LAB 552 and all store addresses in the store buffer 554. In other embodiments, the current slice task includes a second load instruction. The address associated with the second load instruction can be checked against one or more entries within the store buffer 554. If a local alias occurs, the second load instruction can be satisfied by the previously executed store instruction saved in the store buffer 554 which aliased the load. In embodiments, a load instruction that has been saved in the LAB 552 can be used for the alias checking. When the control unit makes the current compute slice the head slice, the stores within the store buffer 554 can be safely flushed to memory, committing the data associated with the store instruction to an architectural state. The committing can include saving the data to a data cache. It should be noted that the mechanisms here disclosed to handle local address aliasing can be extended to the predecessor slice 520 or the successor slice 560.

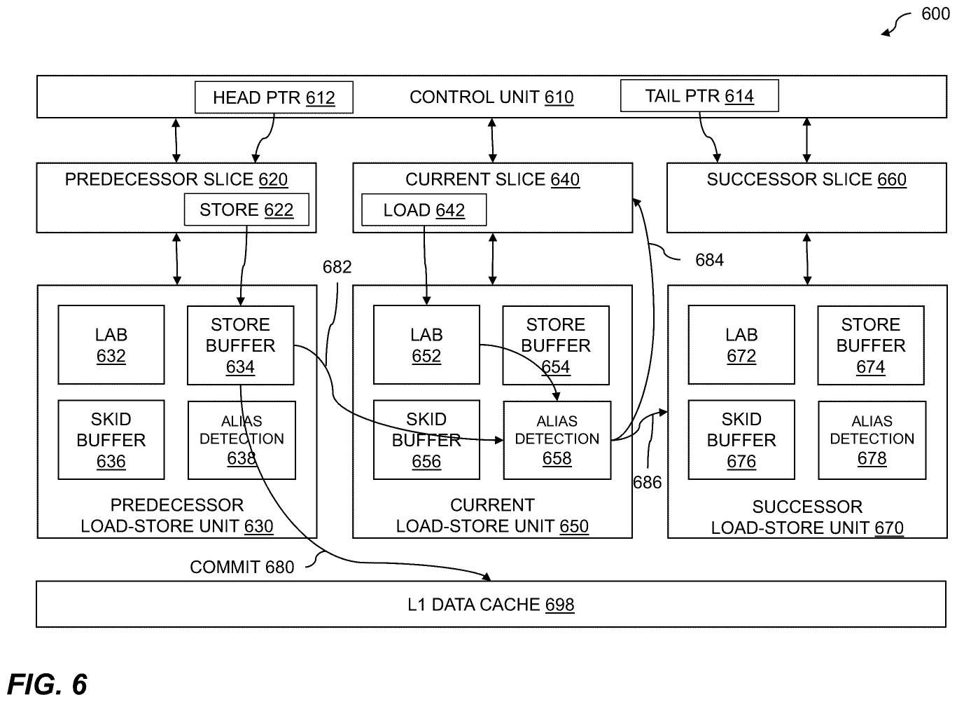

FIG. 6 is a block diagram for slice control with alias detection. As described above and throughout, a compiled program is divided into slice tasks, wherein each slice task contains at least one branch instruction. The dividing can be based on branch prediction logic within the control unit. The control unit can distribute the slice tasks to one or more compute slices. Each compute slice can include its own load-store unit (LSU). In the block diagram 600, three compute slices are shown: a predecessor compute slice 620 (also called a predecessor slice), a current compute slice 640 (also called a current slice), and a successor compute slice 660 (also called a successor slice). A plurality of compute slices can be coupled together in a ring configuration. Additional compute slices can be included in the processor unit. The control unit 610 can distribute a slice task to one or more of the compute slices shown. In the example of block diagram 600, predecessor slice 620 is executing a predecessor slice task that was distributed by the control unit 610. In this example, predecessor slice 620 is the head slice. A head slice is a compute slice which is pointed to by a head pointer 612 within the control unit. In embodiments, when a compute slice is the head slice, it executes its slice task non-speculatively. Current slice 640 is executing a current slice task that was distributed by the control unit 610 speculatively since it is not the head slice. Likewise, successor slice 660 is also running a successor slice task, distributed by the control unit 610, speculatively. Successor slice 660 is the tail slice. A tail slice is a compute slice which is pointed to by a tail pointer 614 within the control unit. In embodiments, the tail pointer indicates the last compute slice in the ring that is executing a slice task.

In the block diagram 600, each compute slice includes its own LSU. Thus, the predecessor slice 620 includes predecessor LSU 630; current slice 640 includes current LSU 650; and successor slice 660 includes successor LSU 670. A plurality of LSUs can be coupled together in a ring configuration. Each LSU can include multiple elements. Predecessor LSU 630 includes a load address buffer (LAB) 632, a store buffer 634, a skid buffer 636, and alias detection logic 638. Additional logic blocks can be included in 630 for additional functions such as address translation, etc. Likewise, current LSU 650 can include an LAB 652, a store buffer 654, a skid buffer 656, and alias detection logic 658. Additional logic blocks can be included in 650 for additional functions such as address translation, etc. Continuing in block diagram 600, successor LSU 670 can include an LAB 672, a store buffer 674, a skid buffer 676, and alias detection logic 678. Additional logic blocks can be included in 670 for additional functions such as address translation, etc. Each compute slice can access an L1 data cache 698. In embodiments, the L1 data cache is shared among two or more compute slices. In other embodiments, each LSU is coupled to its own L1 data cache. The L1 data cache can be coupled to a memory hierarchy which can include an L2 cache, an L3 cache, and so on. Any of the caches can be shared by two or more compute slices. The memory hierarchy can be coherent. Each LSU in the processor unit can be in an active or inactive state. Examples of an active state can include: the LSU has buffered stores in the store buffer; the LSU is executing a load or store instruction; the LSU is in the process of committing a store; and so on. In embodiments, an LSU in the active state transitions to the inactive state after receiving a commit signal from the control unit, once it has completed committing any buffered stores, when it is idle, and so on. In embodiments, an LSU that is in an inactive state is prohibited from forwarding addresses for alias checking to a next LSU in the ring. In the block diagram 600, the predecessor LSU 630, current LSU 650, and successor LSU 670 are all in the active state.

In the block diagram 600, the control unit 610 has distributed a slice task to predecessor slice 620 which is running non-speculatively as the head slice. The predecessor slice task can include a store instruction 622. Since it is running non-speculatively, when finished executing by the predecessor LSU 630, the store instruction 622 can be committed 680 to memory, where the store instruction updates an architectural state. The updating can include saving data to the data cache. Information about the store instruction 622 can be saved in the store buffer 634. In embodiments, the information includes the store address, the data to be stored, and so on. After execution, the store instruction can be called a previously executed store instruction. Thus, in embodiments, the previously executed store instruction was executed by the predecessor LSU, wherein the previously executed store instruction was committed to an architectural state, and wherein the predecessor LSU is in an active state. Further embodiments include propagating, by the predecessor LSU, to the current LSU, the store address associated with the previously executed store instruction.

In embodiments, the current LSU 650 speculatively executes a current slice task from the control unit 610 that includes a load instruction 642. Upon execution of the load instruction 642, the load address can be saved in the LAB 652 of the current LSU 650. In embodiments, the previously executed store address is received 682 from the predecessor store buffer 634. In further embodiments, alias detection is performed which includes the load addresses that have been saved in the LAB and the previously executed store address that was received from the predecessor store buffer. In embodiments, the checking detects the address aliasing. In other embodiments, the checking occurs in a single cycle. When aliasing is detected, the current LSU 650 can cancel 684 the current slice task. Cancelling the slice task is necessary since the load that was executed by the current LSU 650 received data from the memory system before it was updated by the previously executed store instruction to the same address. That is, the load instruction received incorrect data and the execution of that slice task was corrupted. Downstream compute slices can depend on data from the current compute slice. Since an alias was detected, results of the current compute slice are no longer reliable and all active downstream compute slices can be cancelled. Once the current LSU 650 detects aliasing, it can assert an alias detected signal 686. Embodiments include forwarding, by the current LSU 650, to the successor LSU 670, an alias detected signal 686. In embodiments, the current LSU 650 transitions to an inactive state after forwarding the alias detected signal. When the successor LSU 670 receives the alias detected signal, it knows that an earlier LSU detected an alias. Thus, further embodiments include cancelling execution of a successor slice task associated with the successor LSU 670. In embodiments, the earlier LSU can be the current LSU 650. In other embodiments, an earlier LSU, such as the predecessor LSU 630, sends an alias detected signal which is propagated to following LSUs until it reaches the successor LSU 670. The propagating can include one processor unit clock cycle per propagation from one LSU to the next LSU.

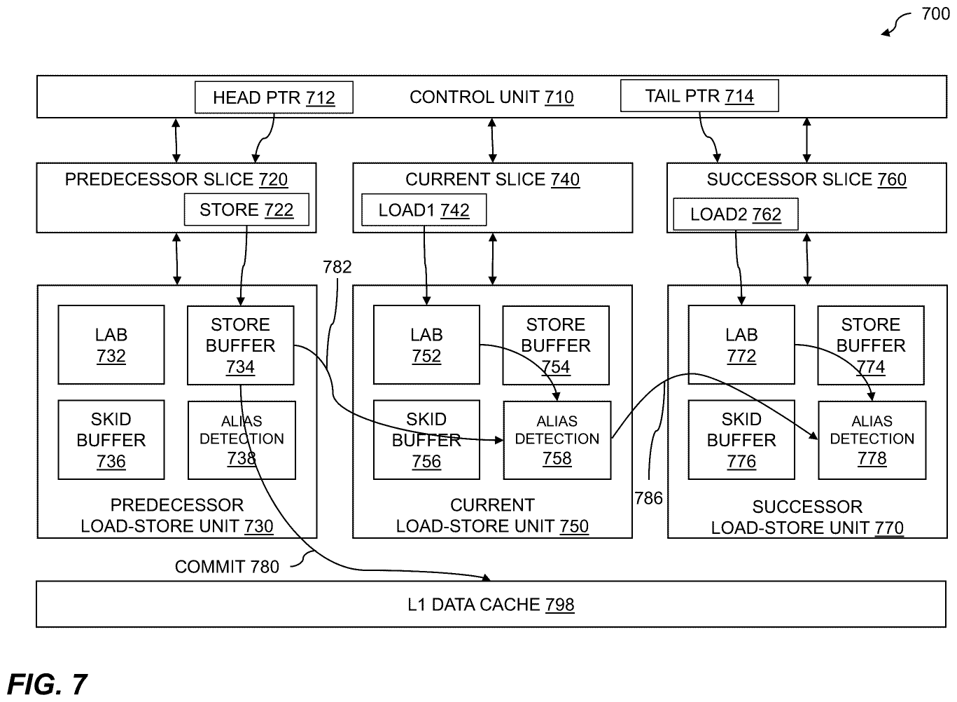

FIG. 7 is a block diagram for slice control with no alias detection. As described above and throughout, a compiled program is divided into slice tasks, wherein each slice task contains at least one branch instruction. The dividing can be based on branch prediction logic within the control unit. The control unit can distribute the slice tasks to one or more compute slices. Each compute slice can include its own load-store unit (LSU). In the block diagram 700, three compute slices are shown: a predecessor compute slice 720 (also called a predecessor slice), a current compute slice 740 (also called a current slice), and a successor compute slice 760 (also called a successor slice). A plurality of compute slices can be coupled together in a ring configuration. Additional compute slices can be included in the processor unit. The control unit 710 can distribute a slice task to one or more of the compute slices shown. In the block diagram 700, predecessor slice 720 is executing a predecessor slice task that was distributed by the control unit 710. In this example, predecessor slice 720 is the head slice. A head slice is a compute slice which is pointed to by a head pointer 712 within the control unit. In embodiments, when a compute slice is the head slice, it executes its slice task non-speculatively. Current slice 740 is executing a current slice task that was distributed by the control unit 710 speculatively since it is not the head slice. Likewise, successor slice 760 is also running a successor slice task, distributed by the control unit 710, speculatively. Successor slice 760 is the tail slice. A tail slice is a compute slice which is pointed to by a tail pointer 714 within the control unit. In embodiments, the tail pointer indicates the last compute slice in the ring that is executing a slice task.

In the block diagram 700, each compute slice includes its own LSU. Thus, the predecessor slice 720 includes predecessor LSU 730; current slice 740 includes current LSU 750; and successor slice 760 includes successor LSU 770. A plurality of LSUs can be coupled together in a ring configuration. Each LSU can include multiple elements. Predecessor LSU 730 includes a load address buffer (LAB) 732, a store buffer 734, a skid buffer 736, and alias detection logic 738. Additional logic blocks can be included in 730 for additional functions such as address translation, etc. Likewise, current LSU 750 can include an LAB 752, a store buffer 754, a skid buffer 756, and alias detection logic 758. Additional logic blocks can be included in 750 for additional functions such as address translation, etc. Continuing in block diagram 700, successor LSU 770 can include an LAB 772, a store buffer 774, a skid buffer 776, and alias detection logic 778. Additional logic blocks can be included in 770 for additional functions such as address translation, etc. Each compute slice can access an L1 data cache 798. In embodiments, the L1 data cache is shared among two or more compute slices. In other embodiments, each LSU is coupled to its own L1 data cache. The L1 data cache can be coupled to a memory hierarchy which can include an L2 cache, an L3 cache, and so on. Any of the caches can be shared by two or more compute slices. The memory hierarchy can be coherent. Each LSU in the processor unit can be in an active or inactive state. Examples of an active state can include: the LSU has buffered stores in the store buffer; the LSU is executing a load or store instruction; the LSU is in the process of committing a store; and so on. In embodiments, an LSU in the active state transitions to the inactive state after receiving a commit signal from the control unit, once it has completed committing any buffered stores, when it is idle, and so on. In embodiments, an LSU that is in an inactive state is prohibited from forwarding addresses for alias checking to a next LSU in the ring. In the block diagram 700, the predecessor LSU 730, current LSU 750, and successor LSU 770 are all in the active state.

In block diagram 700, the control unit 710 has distributed a slice task to predecessor slice 720 which is running non-speculatively as the head slice. The predecessor slice task can include a store instruction 722. Since it is running non-speculatively, when finished executing by the predecessor LSU 730, the store instruction 722 can be committed 780 to memory, where the store instruction can update an architectural state. The updating can include saving data to the data cache. Information about the store instruction 722 can be saved in the store buffer 734. In embodiments, the information includes the store address, the data to be stored, and so on. After execution, the store instruction can be called a previously executed store instruction. Thus, in embodiments, the previously executed store instruction was executed by the predecessor LSU, wherein the previously executed store instruction was committed to an architectural state, and wherein the predecessor LSU is in an active state. Further embodiments include propagating, by the predecessor LSU to the current LSU, the store address associated with the previously executed store instruction.

In embodiments, the current LSU 750 speculatively executes a current slice task from the control unit 710 that includes a load1 instruction 742. Upon execution of the load1 instruction 742, the load1 address can be saved in the LAB 752 of the current LSU 750. In embodiments, the previously executed store address is sent 782 from the predecessor store buffer 734. In further embodiments, alias detection 758 is performed which includes the load1 address that has been saved in the LAB 752 and the previously executed store address that was sent 782 from the predecessor store buffer 734. In embodiments, the checking does not detect address aliasing. In other embodiments, the checking occurs in a single cycle. Since the load1 instruction 742 and the store instruction 722 did not alias, the load instruction received the correct data and the current slice task can continue executing speculatively on the current compute slice 740. It is still necessary that downstream compute slices be checked for address aliasing with the previously executed store instruction. Continuing with the example in the block diagram 700, the successor slice can execute a load2 instruction 762 and save information, including the load2 address, in its LAB 772. The successor slice can continue to execute speculatively. Meanwhile, the address associated with the previously executed store instruction 722 can be sent 786 from the alias detection logic 758 of the current LSU 750 to the alias detection logic 778 of the successor LSU 770. Thus, embodiments can include forwarding, by the current LSU to the successor LSU, the store address associated with the previously executed store instruction. Checking for address aliasing can now be performed between the previously executed store instruction 772 and the load2 instruction 762. Thus, the checking can include the successor LSU 770. If aliasing is detected, the successor slice can be cancelled. If no aliasing is detected, the successor slice can continue to execute speculatively. Additional forwarding of the previously executed store address and checking for address aliasing can continue until an LSU is found in the inactive state.

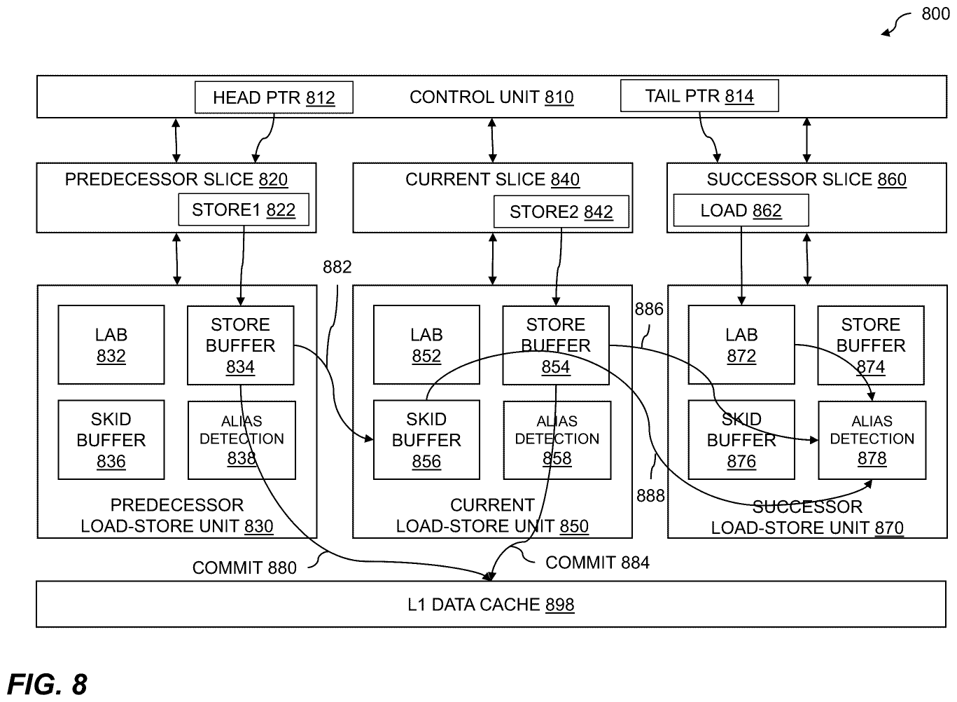

FIG. 8 is a block diagram for slice control with no alias detection. As described above and throughout, a compiled program is divided into slice tasks, wherein each slice task contains at least one branch instruction. The dividing can be based on branch prediction logic within the control unit. The control unit can distribute the slice tasks to one or more compute slices. Each compute slice can include its own load-store unit (LSU). In the block diagram 800, three compute slices are shown: a predecessor compute slice 820 (also called a predecessor slice), a current compute slice 840 (also called a current slice), and a successor compute slice 860 (also called a successor slice). A plurality of compute slices can be coupled together in a ring configuration. Additional compute slices can be included in the processor unit. The control unit 810 can distribute a slice task to one or more of the compute slices shown. In the example of block diagram 800, predecessor slice 820 is executing a predecessor slice task that was distributed by the control unit 810. In this example, predecessor slice 820 is the head slice. A head slice is a compute slice which is pointed to by a head pointer 812 within the control unit. In embodiments, when a compute slice is the head slice, it executes its slice task non-speculatively. Current slice 840 is executing a current slice task that was distributed by the control unit 810 speculatively since it is not the head slice. Likewise, successor slice 860 is also running a successor slice task, distributed by the control unit 810, speculatively. Successor slice 860 is the tail slice. A tail slice is a compute slice which is pointed to by a tail pointer 814 within the control unit. In embodiments, the tail pointer indicates the last compute slice in the ring that is executing a slice task.

In the block diagram 800, each compute slice includes its own LSU. Thus, the predecessor slice 820 includes predecessor LSU 830; current slice 840 includes current LSU 850; and successor slice 860 includes successor LSU 870. A plurality of LSUs can be coupled together in a ring configuration. Each LSU can include multiple elements. Predecessor LSU 830 includes a load address buffer (LAB) 832, a store buffer 834, a skid buffer 836, and alias detection logic 838. Additional logic blocks can be included in 830 for additional functions such as address translation, etc. Likewise, current LSU 850 can include an LAB 852, a store buffer 854, a skid buffer 856, and alias detection logic 858. Additional logic blocks can be included in 850 for additional functions such as address translation, etc. Continuing in block diagram 800, successor LSU 870 can include an LAB 872, a store buffer 874, a skid buffer 876, and alias detection logic 878. Additional logic blocks can be included in 870 for additional functions such as address translation, etc. Each compute slice can access an L1 data cache 898. In embodiments, the L1 data cache is shared among two or more compute slices. In other embodiments, each LSU is coupled to its own L1 data cache. The L1 data cache can be coupled to a memory hierarchy which can include an L2 cache, an L3 cache, and so on. Any of the caches can be shared by two or more compute slices. The memory hierarchy can be coherent. Each LSU in the processor unit can be in an active or inactive state. Examples of an active state can include: the LSU has buffered stores in the store buffer; the LSU is executing a load or store instruction; the LSU is in the process of committing a store; and so on. In embodiments, an LSU in the active state transitions to the inactive state after receiving a commit signal from the control unit, once it has completed committing any buffered stores, when it is idle, and so on. In embodiments, an LSU that is in an inactive state is prohibited from forwarding addresses for alias checking to a next LSU in the ring.

A back-to-back commit sequence can occur when two successive LSUs commit one or more store instructions in back-to-back cycles. In the block diagram 800, the predecessor LSU 830, which is the head slice, has completed the predecessor slice task and has executed a store1 instruction 822, which can be called a previously executed store instruction. The store1 instruction can be committed 880 to an architectural state. The committing can include saving data associated with the store1 instruction to the data cache. The committing can occur on or before cycle N. Meanwhile, the current LSU 850 can complete speculative execution of the current slice task which includes a store2 instruction 842. The previously executed store2 instruction can be saved in the store buffer 854 and is thus ready to commit as soon as it becomes the head slice in the next cycle. In embodiments, the speculative execution can include one or more additional store instructions such as store3, store4, store5, and so on which can be saved in the store buffer 854. Both the store1 and the store2 instructions need to be sent to the successor slice to be checked for aliasing with the load instruction 862 to avoid data corruption. To avoid an idle cycle, a back-to-back commit sequence can be initiated. The skid buffer 856 can enable the forwarding by acting as a holding register. In cycle N, the predecessor LSU can propagate 882, to the current skid buffer 856, the store address of the previously executed store1 instruction 822 which has been committed to an architectural state 880. Since there was no load instruction executing in the current compute slice, alias checking between the predecessor LSU 830 and the current LSU 850 is not necessary. On or before cycle N, the store2 instruction was speculatively executed by the current LSU 850 and was saved in the store buffer 854, waiting to commit.

On the next cycle, N+1, the current LSU 850 can be made the head pointer and commit 884 the store2 instruction to an architectural state. Thus, the back-to-back commit sequence includes committing, by the current LSU 850, one or more other store instructions, one cycle after the predecessor LSU 830 commits the previously executed store1 instruction 822. Also, in cycle N+1, the current LSU can send the store address 886 associated with the store2 instruction to the successor LSU 870 for alias detection 878. Thus, embodiments include forwarding, by the current LSU 850, to the successor LSU 870, the one or more other store addresses associated with the one or more other store instructions 842. The alias detection can include the address of the load instruction 862 which was executed by the successor slice and saved in the successor LAB 872. If aliasing is detected, the successor slice task can be cancelled and an alias detected signal can be sent to subsequent compute slices. If no aliasing is detected, then speculative execution of the successor slice task can continue and the successor LSU can forward the address associated with the previously executed store2 instruction to subsequent LSUs for additional alias detection. The forwarding continues until an LSU is found in the ring that is in the inactive state.

On the following cycle, N+2, the address associated with the previously executed store1 instruction 822, which has been saved in the skid buffer 856, can be forwarded 888 to the successor LSU for alias detection with the address associated with the load instruction 862 that was saved in the successor LAB 872. Thus, embodiments include forwarding, by the current LSU to the successor LSU, the store address associated with the previously executed store instruction from the skid buffer. If aliasing is detected, the successor slice task can be cancelled and an alias detected signal can be sent to subsequent compute slices. If no aliasing is detected, then speculative execution of the successor slice task can continue and the successor LSU can forward the address associated with the previously executed store2 instruction to subsequent LSUs for additional alias detection. The forwarding continues until an LSU is found in the ring that is in the inactive state.

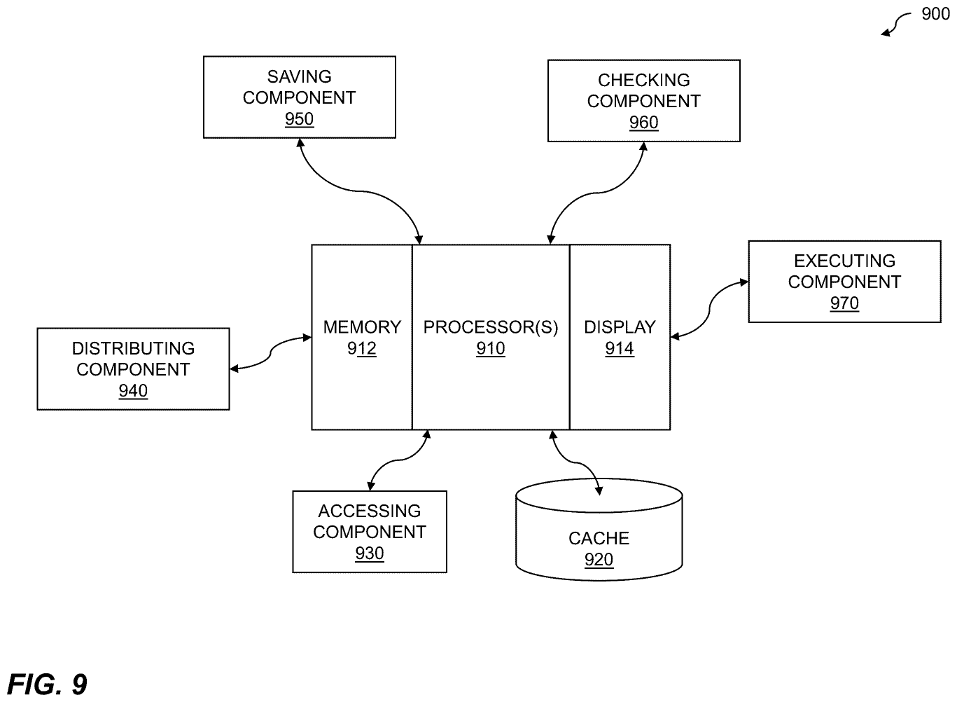

FIG. 9 is a system diagram for semantic ordering for parallel architecture with compute slices. The system 900 can include one or more processors 910, which are coupled to a memory 912 which stores instructions. The system 900 can further include a display 914 coupled to the one or more processors 910 for displaying data; intermediate steps; slice tasks; topologies including systolic, vector, cyclic, spatial, streaming, or VLIW topologies; and so on. In embodiments, one or more processors 910 are coupled to the memory 912, wherein the one or more processors, when executing the instructions which are stored, are configured to: access a processing unit comprising a plurality of compute slices, a plurality of load-store units (LSUs), a control unit, and a memory system, wherein each compute slice within the plurality of compute slices includes at least one execution unit and is coupled to a successor compute slice and a predecessor compute slice, wherein each compute slice within the plurality of compute slices includes a unique LSU in the plurality of LSUs, and wherein each LSU in the plurality of LSUs is coupled to a successor LSU and a predecessor LSU; distribute a current slice task, by the control unit, to a current compute slice in the plurality of compute slices, wherein the current compute slice includes a current LSU, wherein the current slice task includes a load instruction, and wherein the current compute slice is not a head slice; save, in an entry of a load address buffer (LAB) within the current LSU, a load address associated with the load instruction; check for address aliasing between the entry of the LAB and a store address associated with a previously executed store instruction; and execute the load instruction. The compute slices can include compute slices within one or more integrated circuits or chips; compute slices or cores configured within one or more programmable chips such as application specific integrated circuits (ASICs); field programmable gate arrays (FPGAs); heterogeneous processors configured as a mesh; standalone processors; etc.

The system 900 can include a cache 920. The cache 920 can be used to store data such as scratchpad data, slice tasks for compute slices, operations that support a balanced number of execution cycles for a data-dependent branch; intermediate results; microcode; branch decisions; and so on. The cache can comprise a small, local, easily accessible memory available to one or more compute slices. In embodiments, the data that is stored can include operations, data, and so on. The system 900 can include an accessing component 930. The accessing component 930 can include control logic and functions for accessing a processing unit. The processing unit can be accessible within an integrated circuit, an application-specific integrated circuit (ASIC), a programmable unit such as a field-programmable gate array (FPGA), and so on. The processing unit can comprise a plurality of compute slices, a plurality of load-store units (LSUs), a control unit, and a memory system. Each compute slice within the plurality of compute slices includes at least one execution unit. A compute slice can include one or more processors, processor cores, processor macros, processor cells, and so on. Each compute slice can include an amount of local storage. The local storage may be accessible by one or more compute slices. The compute slices can be organized in a ring. Compute slices within the ring can be accessed using pointers. The pointers can include a head pointer, a tail pointer, and the like. Each compute slice is coupled to a successive compute slice and a predecessor compute slice by a barrier register set in the plurality of barrier register sets. The barrier register set provides for communication of data between successive compute slices. Communication between and among compute slices can be accomplished using a bus such as an industry standard bus, a ring bus, a network such as a wired or wireless computer network, etc. In embodiments, the ring bus is implemented as a distributed multiplexor (MUX). Each compute slice can include an LSU. Each LSU can be coupled to a successor LSU and a predecessor LSU. The LSUs can be configured in a ring configuration. Communication between and among LSUs can be accomplished using a bus such as an industry standard bus, a ring bus, a network such as a wired or wireless computer network, etc. In embodiments, the ring bus is implemented as a distributed multiplexor (MUX).

The system 900 can include a distributing component 940. The distributing component 940 can include control and functions for distributing a current slice task to a current compute slice in the plurality of compute slices. The current compute slice includes a current LSU. The current slice task includes a load instruction. The distributing can be accomplished using a bus, a network such as a network-on-chip (NOC), and so on. The distributing is accomplished by the control unit. The distributing the current slice task for the current compute slice can be accomplished when the current compute slice is not the head slice. The head slice can be a state within the control unit and can point to the first compute slice running a slice task non-speculatively.

The system 900 can include a saving component 950. The saving component 950 can include control and functions for saving a load address associated with the load instruction. The load address can be saved in an entry of a load address buffer (LAB) within the LSU, which can be a current LSU. The current LSU can be within the current compute slice. The LAB can include any number of entries including 2, 4, 8, 16, or more. LABs within different LSUs can contain the same or a different number of entries. Each LAB entry can contain a load address associated with a load instruction.

The system 900 can include a checking component 960. The checking component 960 can include control and functions for checking for address aliasing between an entry of an LAB and a store address associated with a previously executed store instruction. An address associated with a previously executed store instruction can be received by a current LSU. In embodiments, the previously executed store address originates from a predecessor LSU. In other embodiments, the previously executed store address originates from the same LSU that executed the load instruction. In further embodiments, the LSU can check the store address that was received with the entries that are in the LAB. The checking can include a single LAB entry. In embodiments, the checking includes multiple LAB entries. In other embodiments, the checking can be based on a hash function of the store address. In further embodiments, the checking can be based on the entire store address. In embodiments, the checking for address aliasing occurs in a single cycle. In other embodiments, the checking for address aliasing occurs in two or more cycles.

The system 900 can include an executing component 970. The executing component 970 can include control and functions for executing the load instruction. If the checking component 960 did not detect address aliasing with a previously executed store instruction, then memory can be safely accessed by the load instruction executing in a current LSU. The execution can include returning, from memory, data associated with the load address. The data can be located anywhere in the memory hierarchy, including L1, L2, L3 caches, or in main memory. In embodiments, the load address is virtual. In other embodiments, the LSU can communicate with a translation lookaside buffer (TLB) to translate the virtual address to a physical address to access the memory hierarchy. The load data that is returned from the memory hierarchy can be stored in registers or other storage elements within the compute slice. The load data can then be used in the execution of subsequent instructions in the slice task.

The system 900 can include a computer program product embodied in a non-transitory computer readable medium for task processing, the computer program product comprising code which causes one or more processors to generate semiconductor logic for: accessing a processing unit comprising a plurality of compute slices, a plurality of load-store units (LSUs), a control unit, and a memory system, wherein each compute slice within the plurality of compute slices includes at least one execution unit and is coupled to a successor compute slice and a predecessor compute slice, wherein each compute slice within the plurality of compute slices includes a unique LSU in the plurality of LSUs, and wherein each LSU in the plurality of LSUs is coupled to a successor LSU and a predecessor LSU; distributing a current slice task, by the control unit, to a current compute slice in the plurality of compute slices, wherein the current compute slice includes a current LSU, wherein the current slice task includes a load instruction, and wherein the current compute slice is not a head slice; saving, in an entry of a load address buffer (LAB) within the current LSU, a load address associated with the load instruction; checking for address aliasing between the entry of the LAB and a store address associated with a previously executed store instruction; and executing the load instruction.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

1. A processor-implemented method for memory operations comprising:
accessing a processing unit comprising a plurality of compute slices, a plurality of load-store units (LSUs), a control unit, and a memory system, wherein each compute slice within the plurality of compute slices includes at least one execution unit and is coupled to a successor compute slice and a predecessor compute slice, wherein each compute slice within the plurality of compute slices includes a unique LSU in the plurality of LSUs, and wherein each LSU in the plurality of LSUs is coupled to a successor LSU and a predecessor LSU;
distributing a current slice task, by the control unit, to a current compute slice in the plurality of compute slices, wherein the current compute slice includes a current LSU, wherein the current slice task includes a load instruction, and wherein the current compute slice is not a head slice;
saving, in an entry of a load address buffer (LAB) within the current LSU, a load address associated with the load instruction;
checking for address aliasing between the entry of the LAB and a store address associated with a previously executed store instruction; and
executing the load instruction.

2. The method of claim 1 wherein the checking did not detect address aliasing.

3. The method of claim 1 wherein the previously executed store instruction was executed by the current LSU.

4. The method of claim 3 further comprising collecting, in a store buffer within the current LSU, address data associated with the previously executed store instruction.

5. The method of claim 4 wherein the checking includes the address data that was collected in the store buffer within the current LSU.

6. The method of claim 5 further comprising returning data, for the load instruction, from the previously executed store instruction, wherein the checking detected address aliasing.

7. The method of claim 6 wherein the checking includes a second previously executed store instruction.

8. The method of claim 6 wherein the current slice task includes a second load instruction.

9. The method of claim 1 wherein the previously executed store instruction was executed by the predecessor LSU, wherein the previously executed store instruction was committed to an architectural state, and wherein the predecessor LSU is in an active state.

10. The method of claim 9 further comprising propagating, by the predecessor LSU to the current LSU, the store address associated with the previously executed store instruction.

11. The method of claim 10 wherein the checking detects address aliasing.

12. The method of claim 11 further comprising cancelling the current slice task.

13. The method of claim 12 further comprising forwarding, by the current LSU to the successor LSU, an alias detected signal.

14. The method of claim 13 further comprising cancelling execution of a successor slice task associated with the successor LSU.

15. The method of claim 10 wherein the checking does not detect address aliasing.

16. The method of claim 15 further comprising forwarding, by the current LSU to the successor LSU, the store address associated with the previously executed store instruction.

17. The method of claim 16 wherein the checking includes the successor LSU.

18. The method of claim 15 further comprising storing, in a skid buffer within the current LSU, the store address that was propagated, wherein a back-to-back store commit sequence occurs.

19. The method of claim 18 wherein the back-to-back store commit sequence includes committing, by the current LSU, one or more other store instructions, one cycle after the predecessor LSU commits the previously executed store instruction.

20. The method of claim 19 further comprising forwarding, by the current LSU to the successor LSU, one or more other store addresses associated with the one or more other store instructions.

21. The method of claim 20 further comprising forwarding, by the current LSU to the successor LSU, the store address associated with the previously executed store instruction from the skid buffer.

22. The method of claim 1 wherein the plurality of compute slices is coupled in a ring configuration.

23. The method of claim 1 wherein the plurality of LSUs is coupled in a ring configuration.

24. The method of claim 1 wherein the checking occurs in a single cycle.

25. The method of claim 1 wherein the head slice is a compute slice which is pointed to by a head pointer within the control unit.

26. A computer program product embodied in a non-transitory computer readable medium for task processing, the computer program product comprising code which causes one or more processors to generate semiconductor logic for:
accessing a processing unit comprising a plurality of compute slices, a plurality of load-store units (LSUs), a control unit, and a memory system, wherein each compute slice within the plurality of compute slices includes at least one execution unit and is coupled to a successor compute slice and a predecessor compute slice, wherein each compute slice within the plurality of compute slices includes a unique LSU in the plurality of LSUs, and wherein each LSU in the plurality of LSUs is coupled to a successor LSU and a predecessor LSU;
distributing a current slice task, by the control unit, to a current compute slice in the plurality of compute slices, wherein the current compute slice includes a current LSU, wherein the current slice task includes a load instruction, and wherein the current compute slice is not a head slice;
saving, in an entry of a load address buffer (LAB) within the current LSU, a load address associated with the load instruction;
checking for address aliasing between the entry of the LAB and a store address associated with a previously executed store instruction; and
executing the load instruction.

27. A computer system for task processing comprising:
a memory which stores instructions;
one or more processors coupled to the memory, wherein the one or more processors, when executing the instructions which are stored, are configured to:
access a processing unit comprising a plurality of compute slices, a plurality of load-store units (LSUs), a control unit, and a memory system, wherein each compute slice within the plurality of compute slices includes at least one execution unit and is coupled to a successor compute slice and a predecessor compute slice, wherein each compute slice within the plurality of compute slices includes a unique LSU in the plurality of LSUs, and wherein each LSU in the plurality of LSUs is coupled to a successor LSU and a predecessor LSU;
distribute a current slice task, by the control unit, to a current compute slice in the plurality of compute slices, wherein the current compute slice includes a current LSU, wherein the current slice task includes a load instruction, and wherein the current compute slice is not a head slice;
save, in an entry of a load address buffer (LAB) within the current LSU, a load address associated with the load instruction;
check for address aliasing between the entry of the LAB and a store address associated with a previously executed store instruction; and
execute the load instruction.
